(19) United States
(12) Patent Application Publication
(10) Pub. No.: US 2007/0272105 A1
(43) Pub. Date: Nov. 29, 2007

(54) APPARATUS AND PROCESS FOR TRANSPORTING LITHOGRAPHIC PLATES TO A PRESS CYLINDER

(76) Inventors: Dennis M. Burgess, Wayzata, MN (US); William J. Campbell, Minnetonka, MN (US)

Correspondence Address: GRAY, PLANT, MOOTY, MOOTY & BENNETT, P.A., P.O. BOX 2906, MINNEAPOLIS, MN, 55402-0906, US

(21) Appl. No.: 11/752,254

(22) Filed: May 22, 2007

Related U.S. Application Data
(60) Provisional application No. 60/808,083, filed on May 24, 2006.

(51) Int. Cl. B41F 27/12

(52) U.S. Cl. 101/477

(57) ABSTRACT

Transportation of a lithographic plate uses an indexer to load plates into pods for delivery to a press cylinder via a pod elevator or a pod cart. The plates are imprinted with a bar code, imaged, punched, bent, sheared, corner notched, and registered to a press cylinder. The plates are loaded into the indexer, which moves the loaded plates into a position in alignment with designated pod compartments, and loads the plates into each of the designated pod compartments by indexed movement of an elevator within the indexer. The pod elevator or the pod cart moves the pods proximate to a press cylinder where the plates are unloaded from the pod and loaded onto a press cylinder. A computing device, such as a PLC, directs the process. A vision system senses information from the indexer, pod, pod elevator, and the plate for feedback to a PLC, which initiates operations of foregoing.

### CROSS REFERENCE TO RELATED APPLICATION

This application claims the benefit of U.S. Provisional Patent Application Ser. No. 60/808,083 filed May 24, 2006.

### FIELD OF TECHNOLOGY

The technology disclosed in this specification is in the field of lithographic plate management and handling for web offset printing. The technology embodies a bar coded (or other coded) apparatus and process for transporting lithographic plates to a press cylinder.

### BACKGROUND

The apparatus and process for transporting lithographic plates to a press cylinder described in this specification has particular (albeit not exclusive) application to management and handling of thin, flexible, lithographic printing plates in high rotational speed press operations.

An embodiment of an apparatus for transporting lithographic plates is comprised of an indexer 2, a pod 3, and a pod elevator 4. Another embodiment of an apparatus for transporting lithographic plates is comprised of an indexer 2 and a cart pod 3a.

An embodiment of the process for transporting lithographic plates to a press cylinder most often operates in conjunction with an over-arching lithographic plate management and handling system 1. The system directs the operation of the indexer 2, pod 3, and pod elevator 4. Among other duties under its control, the system 1 codes each plate. The code contains information, which the system 1 reads at various steps along the way of preparing lithographic plates for use on a printing press. System 1 uses the information to direct the plate along the correct and ultimate route to the printing press, including delivering the plate to indexer 2, signaling indexer 2 to load the plate into various pod compartments 200, and using pod elevator 4 for transporting the plates to a press cylinder.

Indexer 2, pod 3, and pod elevator 4 may be used to load, contain, and transport lithographic plates for web-offset printing, for non web-offset printing, or for non-printing applications. The operation of indexer 2, pod 3, and pod elevator 4 is described in this specification in conjunction with computerized system 1. However, indexer 2, pod 3, and pod elevator 4 may be operated without direction from a computerized system.

The web offset printing operation is highly automated. The heart of the operation is one or more high speed presses designed for efficient mounting and removal of lithographic plates. Each plate must be precisely mounted on the press' plate-mounting cylinder to ensure that the lithographic plate image is in exact registration, i.e., “square” with the press cylinder when in the manufacturer's locked-up position.

In addition to the high rotational speed press—the hub of the operation—the printing operation must have a high speed means of management and handling of the lithographic plates. Management and handling includes identification of each lithographic plate in system 1 and on-time transportation of the plate to the press or presses. The means of identification and transportation of plates includes a plethora of modules, of which indexer 2, pod 3, and pod elevator 4 are a part. Such modules may perform (a) imaging and processing of plates, including bar coding of each plate for identification purposes; (b) image to plate registration and plate to cylinder registration; (c) plate punching, bending, shearing, corner notching/cutting; (d) direction of work flow and plate traffic routing, including optical registration verification, plate inspection, bar-code scanning, and remote diagnostics; (e) on-time delivery of plates to the press, including sorting, stacking, and conveying the plates (using, for example, plate entry modules, rotators, indexers, stackers, crossover bridges, elevators, thru-the-wall transport modules, dual highway modules, auto plate feeders, dummy plate loaders, and conveyors); (f) plate storage (in pods or on stacking cart pods 3a), delivery of pods to storage, and rack storing of pods; and (g) automated retrieval from storage of the indexed plates. The identification and transportation of plates (and the modules which carry-out these functions) must be synchronized with one another and with the press to ensure that the plates are transported to the correct place at the correct time and the various operations on the plates are done timely and properly.

The competitive, low-margin economics of the printing business requires that the press not only be high speed, but so must the management and handling of lithographic plates. In this environment, the plate management and handling infra-structure must be fast, efficient, automated, and reliable to complement the printing process and workflow environment. The plate management and handling system 1 cannot be allowed to contribute to press down time and image register problems. System 1 must ensure the continuous process flow of press-ready, in-register plates for each press cylinder with repeatable results.

The embodiments of the lithographic plate management and handling system 1 and its automated and synchronized, modular components are designed to meet these goals by integrating the entire printing workflow into one efficient system. The lithographic plate management and handling system 1 feeds the press with the lithographic plates. Integrated system 1 is designed to fully automate plate management and handling and reduce operator involvement in the printing process and workflow environment, whether it be in-line or off-line. Integrated system 1 spans the photographic process of imprinting an image on a lithographic plate to locking up the plate on the press.

The embodiments of indexer 2, pod 3, and pod elevator 4 and the other components of system 1 are all designed to automate the workflow of a printing production environment and to produce press-ready plates for applications using different levels of press technology, multiple press types, and multiple press register requirements. No one printing operation is the same, so indexer 2, pod 3, and pod elevator 4 and the other components of system 1 are designed to be flexible in design and configuration. They are designed to be an integrated system with the flexibility to be custom-configured in many different ways. Moreover, indexer 2, pod 3, and pod elevator 4 and the other components of system 1 range from fully automated to un-automated, depending upon the needs of a particular user application.

### SUMMARY

The process for transporting lithographic plates uses an indexer to load plates into a pod compartment for delivery to a press cylinder. The plates are imprinted with a machine readable code, such as bar code. The process includes imaging and processing the plates and punching, bending, shearing, and corner notching the plates. Registration of the plate to a press cylinder occurs during imaging and bending the plate. Registration of the plates occurs when a plate can be precisely located on a press cylinder in accordance with the press manufacturer's plate lock-up specifications, including tolerances. A conveyor moves the imaged plate to the indexer. The plates delivered to the indexer are imaged, processed, punched, bent, sheared, and corner notched, as required, and in register. They are loaded into the indexer and the indexer moves the loaded plates into a position in alignment with designated pod compartments corresponding to bar code information. The indexer loads the plates into each of the designated pod compartment by indexed movement of the indexer's elevator to align the designated plates with each of the plates corresponding pod compartments. A pod elevator moves the pods proximate to a press cylinder where the plates are unloaded from the pod and loaded onto a press cylinder. A computing device, such as a PLC, directs the process. The computing device has a memory for storing parameters corresponding to virtual locations of modules such as a conveyor, the indexer, the pod, a pod compartment, a pod elevator, and a press cylinder. The computer stores physical locations of the plates, machine readable codes on the plates, feedback information from the modules, and instructions for directing movement of the plates along routes based upon preset parameters. The computer includes a processor for executing the instructions, an input channel for receiving and storing the instructions and the parameters, and an output channel for sending the instructions to a module for directing an operation and moving the plates along routes. A vision system is used for sensing information from a module and from a plate for feedback to a PLC, which initiates operations of a module and for bar-code scanning.

The plate indexer has a box frame, housing, elevator, indexer conveyor, plate centering assemblies, and plate finger pushers. An internal frame is secured to the box frame for support of the elevator. The elevator is vertically movable within the frame and the housing and in a first position the elevator is in a plate loading position and in a second position the elevator is in a plate exiting position. The elevator is raised and lowered by a drive motor having a worm gear assembly and a speed reduction adapter. The indexer conveyor has one or more horizontally, rollable belts and a means for rollably moving the belts. The plate centering assemblies include a means for pushing the plate into lateral registration with belts. At least one assembly positioned on each longitudinal side of the plate. Finger pushers are mounted on each longitudinal side of the plate for gripping the plate with the finger springs and thereby move the plate into registration with the bed of the elevator. The plate assist assembly has a rod less cylinder mounted over the top of the indexer conveyor in a direction parallel to movement of the belts, a first a sensor for detecting the trailing edge of a plate and in response thereto the PLC signals the plate assist assembly to move the plate into a pod compartment and thereafter return to its start position.

The pod is a combination of a housing, partitioned compartments within the housing, a support bracket spanning the housing for rotatably mounting the pod in a pod elevator, a hangar for supporting a plate when the pod is in a vertical position within the pod elevator, a means for engaging a bend on the plate with the hangar, and a means for ejecting a plate from of the pod. The housing includes an enclosure, a retainer opposite the enclosure, the partitioned compartments between the enclosure and the retainer, and a support bracket spanning the enclosure, the compartments, and the retainer for rotatably mounting the pod in a pod elevator. Each pod has multiple compartments, support brackets, hangars, a dual rod cylinder for engaging a bend on the plate, an ejecting for ejecting the plate. The compartments are vertically spaced apart parallel partitions. Upper pod support brackets are on an upper pod and lower pod support brackets are on a lower pod. The plates are loaded in a horizontal position. The assigned pod compartments are successively loaded with corresponding coded plates by incremental movement of the indexer elevator. The pod elevator swivels the pods and their contained plates into a vertical position and transports the pods in a pod elevator proximate to a press cylinder. The support brackets have apertures for rotatable engagement with a pivot shaft of the pod elevator. A signal is sent to open a pod door, eject the plate from a designated pod compartment, and upon reaching the end of a plate ejector's travel retract the ejector to its home position.

The pod elevator transports the pods proximate the press cylinder. It is comprised of a frame, an outer carriage movable within the frame, an upper pod movable within the outer carriage, an inner carriage movable within the outer carriage, and a lower pod movable within the inner carriage. The frame is constructed of frame members, mounting frame members, back frame members, stabilizers, cross-members, and legs. The frame is built in two sections, which are a frame top portion and a frame bottom portion. The top portion is cantilevered over the bottom portion. The outer carriage is a combination of a frame with left and right side channels and top and bottom angle brackets, a guide rail affixed to the inside of the left channel, a guide rail affixed to the inside of the right channel, two guide roller assemblies mounted on the top angle bracket positioned to the left and right of the side channels, two guide roller assemblies mounted on the bottom angle bracket positioned to the left and right of the side channels, a cable cylinder mounted to the top and the bottom angle brackets and a cable attached to a top angle bracket of the inner carriage by a cable travel stop, a rotatable shaft in opposing end bearings, the bearings affixed to the left and the right side channels, a pivot affixed at one end in a pre-determined angular position to the shaft and rotatably connected at the other end to a cylinder and the top end of the cylinder rotatably connected to the bottom of the top angle bracket. The inner carriage includes a frame with left and right side channels and top and bottom angle brackets, four guide roller assemblies mounted on the top and the bottom angle brackets positioned outside of the left and right side channels, a shaft in end bearings, a pivot affixed between the shaft and a cylinder rod and the cylinder pivotally affixed to the top angle bracket. The pod elevator can have a number of pods within it, but the embodiment shown in this specification has two pods. Support brackets are on top of the upper pod and support brackets are on the bottom of the lower pod. The outer carriage has a rotatable shaft in opposing end bearings, the bearings affixed to left and right side channels and one end of a pivot affixed to the shaft in a pre-determined angular position, the other end of the shaft rotatably affixed to a cylinder, and the top end of the cylinder rotatably affixed to the top angle bracket. An upper pod is rotatably affixed on the shaft by insertion of the shaft though apertures in the upper support brackets. The outer carriage cylinder is actuated to extend the rod downward to clockwise rotate the shaft and the upper pod 90° upward. The inner carriage is comprised of a rotatable shaft in opposing end bearings, the bearings affixed to the left and right side channels and one end of a pivot affixed to the shaft in a pre-determined angular position, the other end of the shaft rotatably affixed to a cylinder, and the top end of the cylinder rotatably affixed to the top angle bracket. The lower pod is rotatably affixed on the shaft by insertion of the shaft though apertures in the lower support brackets. The inner carriage cylinder is actuated to extend the rod downward to clockwise rotate the shaft and the lower pod 90° upward. The elevator has the following modes of operation: load plate mode, separate pod mode, rotate pod mode, lower pod mode, eject plate mode, and return home mode. In the load plate mode the upper pod is positioned horizontally on the upper shaft in the outer carriage, the lower pod is positioned horizontally on the lower shaft in the outer carriage, the bottom of the upper pod abuts the top of the lower pod, whereby the indexer can load the upper and lower pods as if they were a single pod. In the separate pod mode the horizontal upper pod remains stationary and the horizontal lower pod separate from the upper pod by movement of the inner carriage downward to the bottom of the outer carriage at least a distance from the outside of the channel shaped retainer to the outside of the enclosure. In the rotate pod mode the upper and lower pods are rotated upward from their horizontal positions to vertical positions. In the lower pod mode the outer carriage moves along with the vertical upper pod, towards the bottom of the elevator, the inner carriage, located at the bottom of the outer carriage, moves along with the vertical lower pod to the bottom of the elevator, wherein the upper pod remains in it vertical position about the vertically positioned lower pod. In the eject plate mode designated plates are ejected from compartments in the upper and lower pods. In the return home mode the elevator is directed to return to its home position for loading. the inner carriage cylinder is actuated to extend the rod downward to clockwise rotate the shaft and the lower pod 90°.

### DESCRIPTION OF DRAWINGS

FIG. 1 is a plan view of an embodiment of a production line configuration of system 1, which includes indexer 2, pod 3, and pod elevator 4.

FIG. 2 is a perspective view of an embodiment of indexer 2 with its elevator in an up position.

FIG. 3 is a perspective view of an embodiment of indexer 2 with its elevator in a down position.

FIG. 4 is another perspective view of an embodiment of indexer 2 with its elevator in an up position.

FIG. 5 is an exploded view of a portion of the embodiment of indexer 2 illustrated in FIG. 4.

FIG. 6A is a perspective view of conveyor system 154 of an embodiment of indexer 2.

FIG. 6B is an exploded view of conveyor system 154 of an embodiment of indexer 2.

FIG. 7A is a perspective view of plate assist assembly 151 of an embodiment of indexer 2.

FIG. 7B is an exploded view of plate assist assembly 151 of an embodiment of indexer 2.

FIG. 8 is a perspective view of finger pusher assemblies 106 of an embodiment of indexer 2.

FIG. 9 is a perspective view of an embodiment of upper pod 3, fully loaded with plates.

FIG. 10 is a perspective view of an embodiment of lower pod 3, fully loaded with plates.

FIG. 11 is a perspective view of an embodiment of upper pod 3 with one partially loaded plate.

FIG. 12 is a perspective view of an embodiment of lower pod 3 with one partially loaded plate.

FIG. 13 is a perspective view of an embodiment of upper pod 3 without any plates loaded.

FIG. 14 is an exploded view of an embodiment of upper pod 3.

FIG. 15 is a perspective view of an embodiment of lower pod 3 without any plates loaded.

FIG. 16 is an exploded view of an embodiment of lower pod 3.

FIG. 17 is an exploded view of an embodiment of upper pod 3 partition and ejector.

FIG. 18 is an exploded view of an embodiment of lower pod 3 partition and ejector.

FIG. 19 is a perspective view of an embodiment of pod elevator 4 in the load plate mode.

FIG. 20 is a perspective view of an embodiment of pod elevator 4 in the pod separation mode.

FIG. 21 is a perspective view of an embodiment of pod elevator 4 in the rotate pod mode.

FIG. 22 is a perspective view of an embodiment of pod elevator 4 in the lowering pod mode.

FIG. 23 is a perspective view of an embodiment of pod elevator 4 in the ejecting plate mode.

FIG. 24 is a perspective view of an embodiment of outer carriage of pod elevator 4 with the inner carriage in the up position.

FIG. 25 is a perspective view of an embodiment of outer carriage of pod elevator 4 with the inner carriage in the down position.

FIG. 26 is an exploded view of an embodiment of outer carriage of pod elevator 4 with the inner carriage in the up position.

FIG. 27 is a perspective view of an embodiment of inner carriage of pod elevator 4.

FIG. 28 is an exploded view of an embodiment of inner carriage of pod elevator 4.

FIG. 29 is a perspective view of an embodiment of inner carriage of pod elevator 4.

### DESCRIPTION OF EMBODIMENTS

System Level

Lithographic plate management system 1 is comprised of modules arranged in differing configurations to form myriad work flow systems. The main working modules are the imager 18, image processor 9, punch/bender 19, indexer 2, pod 3, and pod elevator 4. These modules are serviced by transport modules of various kinds. System 1 provides plate traffic control and tracking along the entire transport route. Some transport modules, under control of system 1, transport plates forward or backward and right or left. They pause, hold, stop, start, slow down, speed up, rotate, index, sort, stack, elevate, or eject. The transport modules move press-ready plates to designated printing press locations.

Selected Modules

Plate indexer 2 receives the press-ready lithographic plates from belt transporter 8 or some other module in system 1 and loads each plate into a designated compartment 200 of pod 3 for delivery to the press. Pod 3 has several compartments that are separated from one another by parallel partitions, each of which is in a separate vertically spaced position. Pod elevator 4 moves the pods vertically from indexer 2 level to a second level in which the printing press is located.

System controller 31 includes a programmable logic controller. It is the operating brain of system 1. It supervises the entire plate management and handling system 1. Among other things, it manages, monitors, and controls plate flow, system operation, alarms, and fault detection. It reports the need for preventative maintenance and does trouble-shooting.

Production Line Configurations

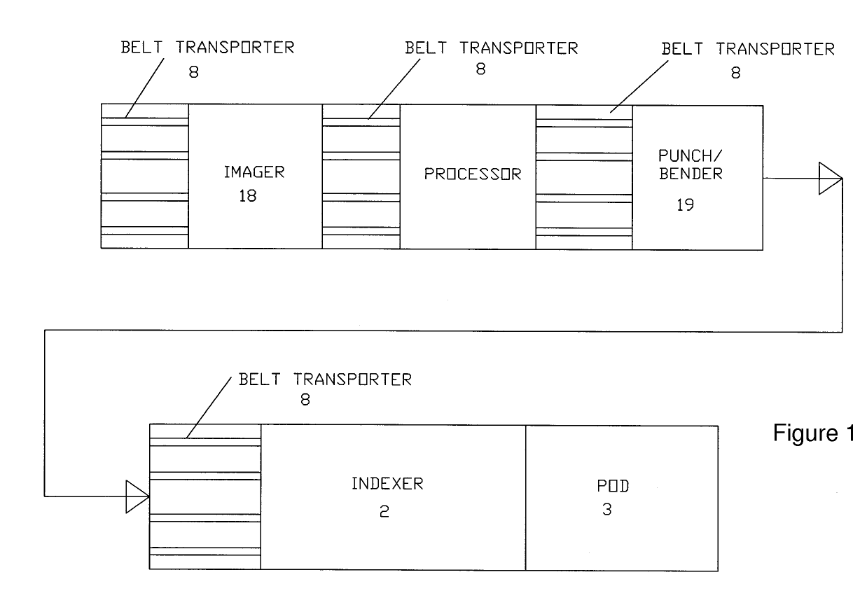

An embodiment of the computer to plate lithographic plate management and handling system 1 is illustrated in FIG. 1, a plan view. The main elements of system 1 include imaging module 18, plate rotation module 20, multi-directional plate transfer module 16 to change the direction of flow of the plate after leaving the imaging module 18, processor 9, plate stacker 17, plate punch/bender module 19, and plate stacker 17.

Indexer

Indexer module 2 is part of an integrated group of devices for transporting, loading, ejecting, and orienting plates. Indexer 2 pushes plates into a container (a pod 3) in succession by lowering the container incrementally as the plates are loaded into it by the pusher resulting in plates stacked in individual positions (compartments 200) one above another. The container can be swiveled through an arc of 90 degrees.

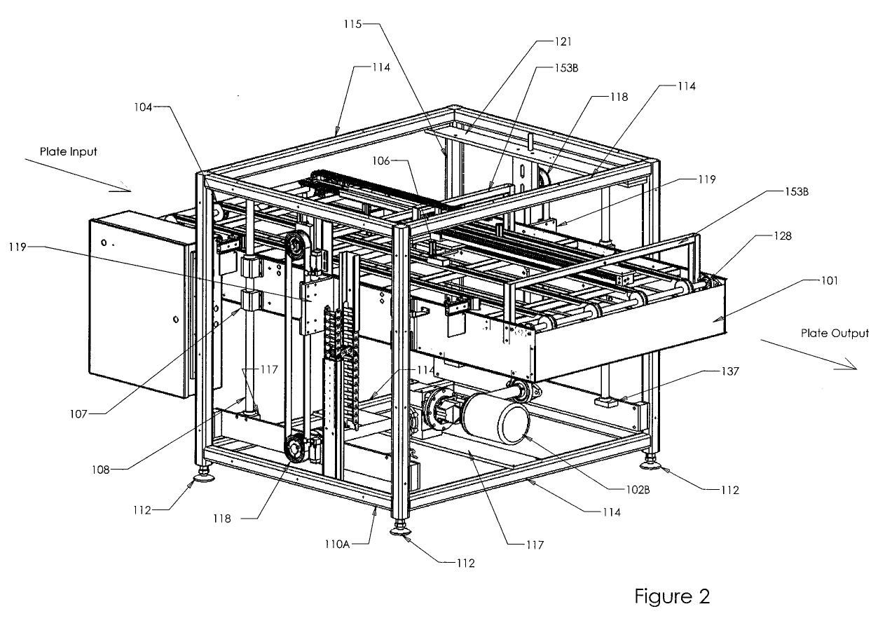

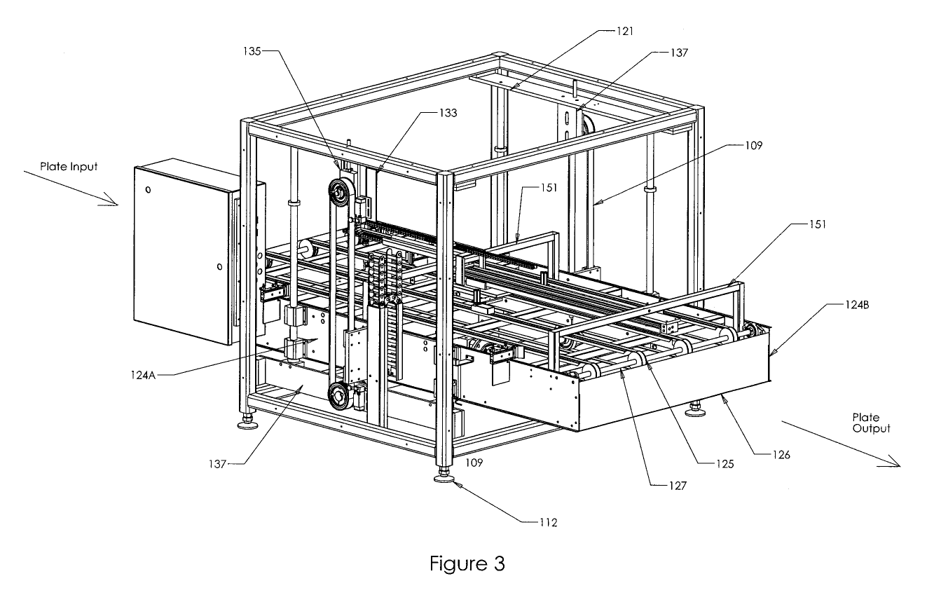

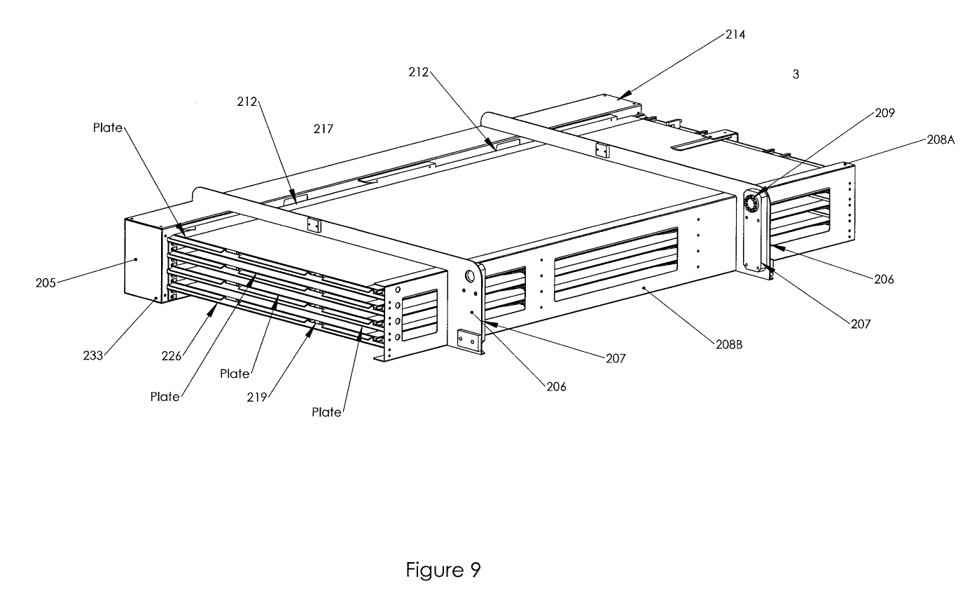

After the printing plates pass through bender 19 (such as that described in U.S. Pat. No. 5,970,774) to form bends at the edges of the plate, they are placed sequentially on multi-directional transporter 16, dual lift up conveyor 23, or belt transporter 8 and transported horizontally for delivery to indexer 2. An embodiment of indexer 2 is shown in FIGS. 2-3. Plate indexer 2 receives the press-ready lithographic plates, one at a time, from belt transporter 8, which is configured in-line with indexer conveyor 154. Indexer conveyor 154 is a loading module. It loads each of the plates in a pod 3 (or a cart pod 3a) designated by system 1 for delivery to the press. Pod 3 is shown in FIGS. 9-18. Pod 3 has several compartments 200 that are separated from one another by parallel partitions, each of which are in separate vertically spaced positions.

As a plate begins to exit belt transporter 8, it enters indexer conveyor 154. A first sensor 184 of indexer 2, senses the entry of the leading edge of incoming plate and automatically initiates forward movement of indexer conveyor 154. Indexer conveyor 154 operates at the same speed as does belt transporter conveyor 8. Indexer conveyor 154 moves the plate to a position proximate a second sensor 185, which stops further plate movement. At the point when the plate is stopped, the plate is fully loaded into indexer conveyor 154. Elevator 101, operating under system controller 31, moves vertically so that indexer conveyor 154 (with encoded information on the plate, such as a bar code) is in horizontal alignment with the bar coded plate's assigned pod compartment 200. Look-up table 32 in the memory of system controller 31 (a programmable logic controller) is pre-programmed with an index of all of compartments 200 of pod 3. System controller 31 associates each of the imprinted bar codes with a single indexed compartment 200 of each pod 3. Typically, each of the printing plates moving within system 1 is imprinted with a bar code during, for example, the plate's initial entry into system 1. Each indexed compartment 200 is at a pre-determined vertical position of indexer 2 and it is stored in system controller 31. In one embodiment, there may be 16 compartments. Therefore, for example, if a plate with bar code AAA is loaded into indexer conveyor 154, system controller 31 will sense the AAA bar code, associate it with the plate assigned to a particular compartment (9^{th} compartment, for example), and signal elevator 101 to move up or down, as the case may be, to the 9^{th} compartment. The now vertically moving elevator 101 will sense when it has reached the vertical location of the 9^{th} compartment by reference to the indexer's linear encoder, which senses elevator's 101 position, and will stop moving at the 9^{th} compartment. At this juncture, plate pusher finger assemblies 106 (for example, 2 opposing assemblies proximate each side of plate) orient the plate so it's alignment on elevator 101 is in alignment with its assigned pod compartment 200. The plate is then ready for interference free movement into the assigned pod compartment 200. At the pre-determined vertical position, system controller 31 signals indexer conveyor 154 to begin forward movement of plate into its assigned compartment 200. When the trailing edge of the plate is sensed by second sensor 185, system controller 31 signals plate assist assembly 151 to push the trailing edge of the plate fully into its compartment 200. After insertion of the bar coded plate into pod 3, system controller 31 signals indexer elevator 101 to return to the belt transporter 8 level for receipt of another plate from belt transporter 8—indexer handles one plate at a time. After receipt of the plate, elevator 101 again begins its stepwise vertical movement until its reaches the designated compartment for the plate, at which point elevator 101 stops. As described previously, the plate is placed in its respective indexed compartment 200 and so begins anew the next series of cycles.

Indexer 2 is configured so that system controller 31 of system 1 can pause the operation of indexer 2 and thereby stop movement of press-ready plates already in indexer 2. System 1 can also pause the operation of any conveyor 8 and thereby stop movement of any plate enroute to indexer 2. System controller 31 is programmed to direct indexer 2 and other modules in system 1 when, for example, other plates are on a trajectory to intersect press-ready plates already in indexer 2 or enroute on a conveyor 8 to indexer 2. In a highly configured system 1, system controller 31 may need to frequently control traffic due to multipathing of plates to multiple presses and the intersection of the multi-paths. System controller 31 acts like a stop and go light; stopping movement on some pathways while allowing movement on an intersecting pathway for higher priority plates for collisions avoidance.

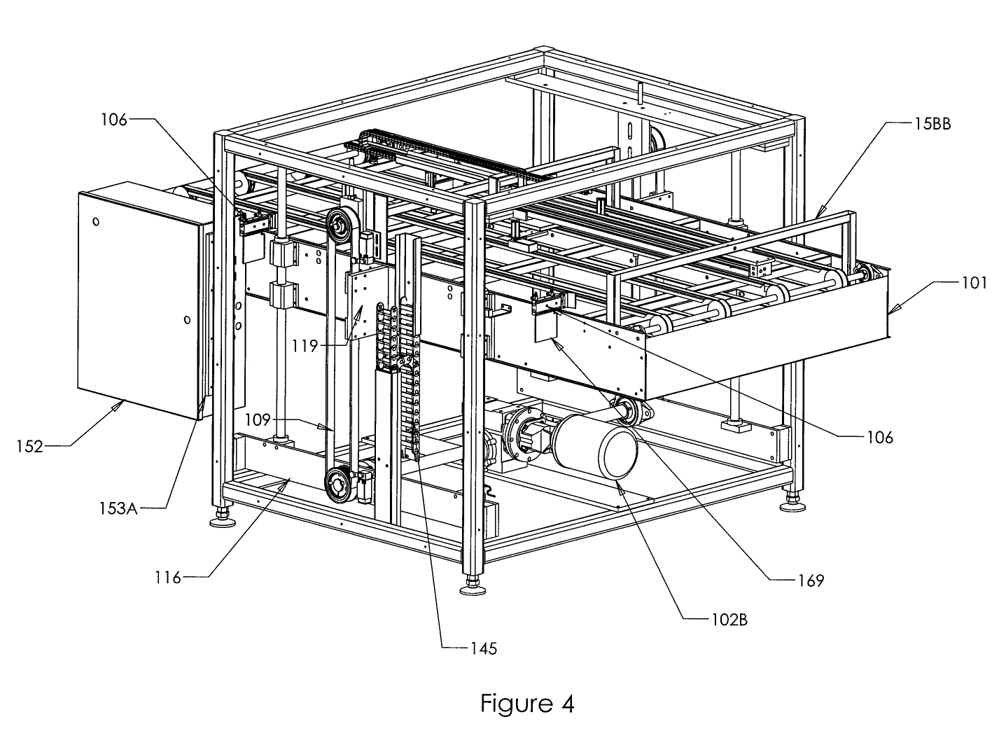

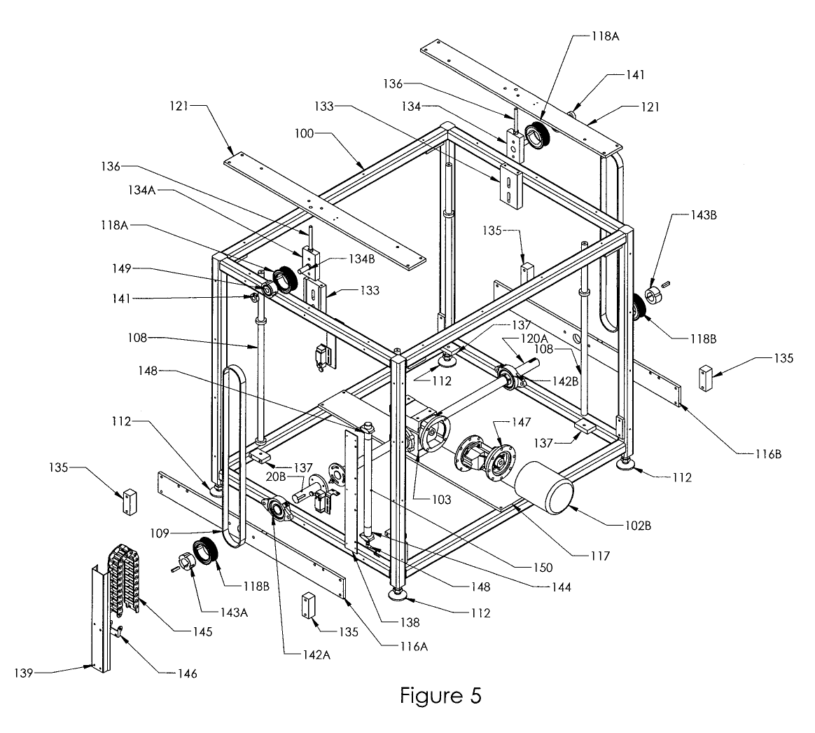

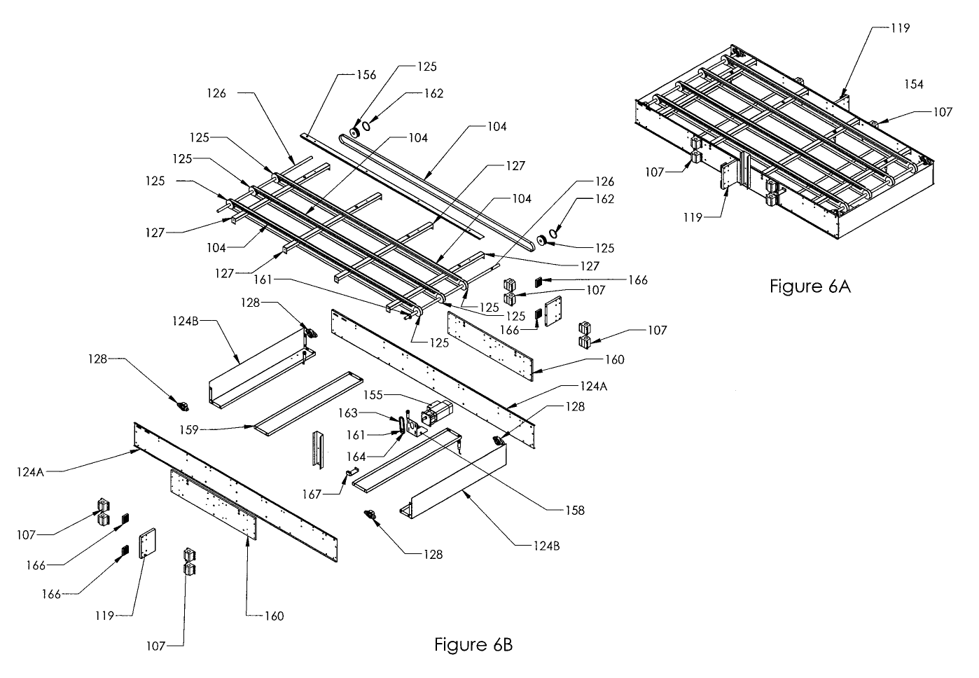

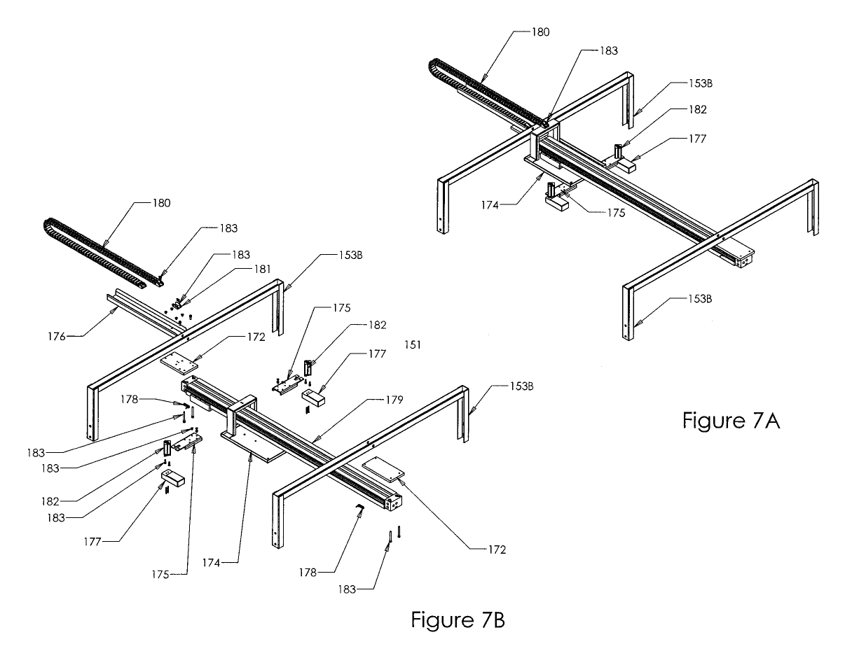

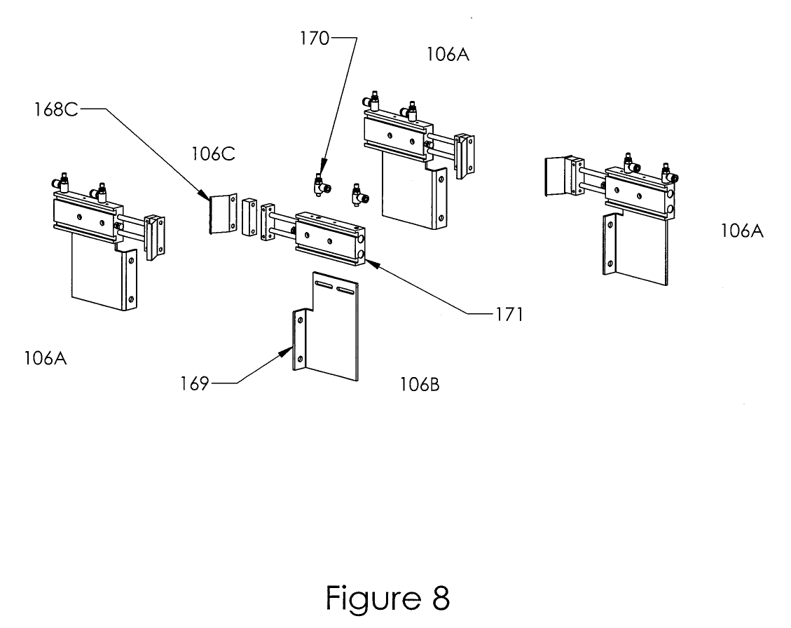

FIG. 2 is a perspective view of an embodiment of indexer 2 with its elevator 101 in an up position. FIG. 3 is a perspective view of an embodiment of indexer 2 with its elevator 101 in a down position. FIGS. 2-3 illustrate indexer 101 with its elevator 101 in-line with side horizontal frame members 110A. FIG. 4 is also a perspective view of an embodiment of indexer 2 with its elevator 101 in an up position. FIG. 8 is an exploded view of a portion of the embodiment of indexer 2 illustrated in FIG. 7. The embodiments of FIGS. 7-8 illustrate indexer 2 with its elevator 101 in-line with end horizontal frame members 110B as opposed to FIGS. 6A-6B, in which elevator 101 is rotated 90° from elevator 101 of FIGS. 7-8. The embodiments shown in FIGS. 2-5 are the same with the exception of the orientation of elevator 101 with respect to the horizontal frame members. Therefore, the description which follows will make no distinction between the two orientations. Elevator 101 orientation is chosen to fit the configuration of the production line in which indexer 2 will be used.

Indexer 2 is comprised of frame 100, housing 113, elevator 101, elevator drive system 102A, indexer conveyor 154, plate centering assembly 105, and plate finger pusher assembly 106.

An embodiment of frame 100 is a box frame, as shown in FIGS. 2-3, with side horizontal frame members 110A, end horizontal frame members 110B, vertical frame members 111, and leveling pads 112. Leveling pads 112 are adjustable for leveling indexer 2. Horizontal and vertical frame members 110A, 110B, and 111 must be of an adequate size and have adequate strength to steadily support elevator 101 and the other parts of frame 100 with little flexing. Tubular or square steel tubing is acceptable for this purpose.

Housing 113 is secured to frame 100. Housing 113 provides an internal frame for elevator 101, elevator drive motor 102B, and worm gear box 103. Housing 113 comprises horizontal housing members 114, vertical housing members 115, side plates 116, and drive motor support 117.

Elevator 101 is movable vertically within frame 100 and housing 113. Elevator 101 is formed of lightweight side box beams 124A and end box beams 124B with parallel top cross members 127 extending laterally between parallel side box beams 124A for lateral strength. Elevator 101 can be in a down position to receive a lithographic plate and then raised to an elevated position for exiting the plate from indexer 2 into pod 3 or plate rack 10 for delivery to the press. Alternatively, elevator 101 can be in an elevated position to receive a lithographic plate and then lowered to a down and/or up position for exiting the plate from indexer 2 into pod 3 or plate rack 10 for delivery to the press.

Elevator drive system 102A raises and lowers elevator 101. Elevator drive system 102A is comprised of drive motor 102B, 4:1 helical adapter 147, worm gear box 103, drive shafts 120A and 120B, bearings 142A and 142B, side plates 116A and 116B, spacer plates 135A and 135B, taper lock adapters 143A and 143B, upper drive belt pulleys 118A, lower drive belt pulleys 118B, open drive belt 109, open drive belt clamp plate 119, open drive belt clamps 166, side plate 160, single split collar 141, taper lock idler 149, idler mount 134, take-up bolt 136, take-up mount 133, top plate 121, linear shafts 108, linear shaft mounting block 137, and linear bearings 107.

Drive motor 102B, an AC motor, is connected to 4:1 helical adapter 147, which reduces the drive motor's speed to ¼ its output rpm. The output of 4:1 helical adapter 147 is delivered to worm gear box 103 and then to drive shafts 120A and 120B. Drive shafts 120A and 120B run in bearings 142A and 142B. Bearings 142A and 142B are mounted on the backside of side plates 116A and 116B. Spacer plates 135A and 135B offset side plates 116A and 116B inwardly from frame 100 for clearance from outside of frame 100. Drive shafts 120A and 120B extend through an aperture in each side plate 116A and 116B and are engaged by taper lock adapters 143A and 143B, which are affixed inside lower drive belt pulleys 118B. Open drive belt 109 engages upper and lower drive belt pulleys 118A and 118B. Upper drive belt pulleys 118A include taper lock idlers 149 fixedly engaged within the hubs of upper drive belt pulley 118A. Shaft 134B of idler mount 134A rotatably extends through apertures in taper lock idlers 149 and are held in place by single split collars 141. Idler mounts 134A are held in place by take-up mounts 133, which are affixed to horizontal frame members 110 and to top plates 121. Top plates 121 are also affixed to horizontal frame members 110A. Take-up bolt 136 is adjustable to increase or decrease tension in open drive belts 109 and it extends through top plates 121 for easy access. The ends of open drive belt 109 attach to open drive belt clamp plate 119 and are clamped to open drive belt support 119 by open drive belt clamps 166. Open drive belt clamp plate 119 is attached to elevator 101. Motor drive shafts 120A and 120B protrude through side plates 116A and 116B and connect with their respective upper and lower drive belt pulleys 118A and 118B. Side plates 116A and 116B are attached to vertical housing members 115 at the bottom of the vertical housing members. Each linear shaft 108 is fixed at its ends within a mounting block 137, so that it neither rotates or moves vertically. Linear bearings 107 are attached to elevator 101. Each linear shaft 108 rides within two linear bearings 107 allowing elevator 2 to move smoothly in a vertical direction. Upper drive belt pulleys 118A and 118B are indirectly attached to upper horizontal housing members 114. Elevator drive motor 102 is seated on drive motor support 117 and fastened to horizontal housing member 114. Motor drive shafts 120A and 120B extend from each side of elevator drive motor 102B and extend through side plates 116A and 116B and into lower drive belt pulleys 118A and 118B on each side of indexer 2. Elevator drive motor 102B is configured with 60:1 speed reducer 123 for transmission of power from its armature, which is in-line with drive motor 102B housing, to drive shafts 120A and 120B, which are perpendicular to elevator drive motor 102 armature.

FIGS. 6A-6B best illustrate indexer conveyor 154. A series of web pulleys 125 are affixed to drive shafts 126. The ends of each drive shaft 126 are rotatably affixed into bearings 128. Bearings 128 are affixed to side box beams 124A parallel to top cross members 127 near end box beams 124B. The two web pulley 125/drive shaft 126 combinations are mounted near each end box beams 124B and in parallel to each, so flat web belts 104 can be rollably affixed to in-line web pulleys 125 near each end box beam 124B. Flat web belts 104 move around web pulleys 125 in parallel with side box beams 124A and other web pulleys 125. Web pulleys 125 move longitudinally by chain drive 130 connected to sprockets 131 on drive shafts 126. Chain drive 130 is driven by an electric motor.

Plate centering assembly 105 is mounted perpendicular to side box beams 124A. It may be comprised of a pneumatic or electrical actuator assembly. The push rod of a pneumatic actuator moves the lithographic plate laterally after it enters elevator 101. In one embodiment, there are four plate centering assemblies 105. The number of plate centering assemblies depends to some extent upon the size of the plate. Smaller plates may be centered by 2 or 3 assemblies 105. Indexer 2 is programmed so that each of the plate centering assemblies 105 work in conjunction with one another to move the plate in a lateral registration position. After the plate has entered indexer 2, plate finger pusher assembly 106 adjusts the position of a plate on bed 132 of elevator 101 to be in registration with the bed. The registration position on the bed is established so that when the plate begins to be ejected from indexer 2 it will travel in a pre-set direction within the ambit of a defined path that is in-line with the entry point of pod 3. If the plate is not in registration, it may jam within indexer 2 or with pod 3 as it is ejected from indexer 2.

Plate finger pusher assemblies 106A and B are best illustrated in FIG. 8. FIG. 8 is a perspective view of assemblies 106A, of which there are three, and is an exploded view of assembly 106B, of which there is one. Assemblies 106A and 106B are identical to one another. Two assemblies 106 are mounted on each side of the lithographic plate and move the plate for proper positioning on indexer 2. Assembly 106 is comprised of dual rod cylinder 171, finger spring 168A, finger spring block 168B, cylinder bracket 169, and flow control fitting 170. Two finger pusher assemblies 106 are attached to each side box beam 124 of elevator 101 by cylinder bracket 169, as shown in FIG. 4 Dual rod cylinder 171 is operated pneumatically. Flow control fitting 170 has a port, the size of which is manually adjustable by a port handle to decrease or increase the amount of air entering the cylinder and thereby driving the movement of the cylinder. Too much air may over-drive the rod and damage the plate. Too little may not move the plate into position. Finger spring 168A is a compliance spring. It is attached to block 168B. It introduces some spring back when it connects with the plate so the plate will not be damaged. V-portion 168C is the contact point with the plate.

Plate assist assembly 151 is illustrated in FIGS. 7A-7B. When the trailing edge of a plate is sensed by second sensor 185, system controller 31 signals plate assist assembly 151 to push the trailing edge of the plate fully into its compartment 200. Plate assist assembly 151 is mounted over the top of indexer conveyor 154. Plate assist mounts 153B are mounted between side box beams 124A on elevator 101. One plate assist mount 153B is mounted proximate the plate exit point of indexer conveyor 154 and the other plate assist mount 153B is mounted proximate the center of indexer conveyor 154. Rod less cylinder mounts 172 are affixed on plate assist mounts 153B at the center-line of each mount 153B and rod less cylinder 179 is mounted to rod less cylinder mounts 172. Rod less cylinder 179 is mounted in a direction parallel to movement of flat web belts 104 on indexer conveyor 154. Base cylinder mount 174 is affixed to rod less cylinder 179 and slides forward from its position near centrally disposed plate assist mount 153B when system 1 signals it to push a plate into its respective compartment 200. A pusher assembly is mounted to base mount cylinder 174 at its leading edge when pushing a plate. The pusher assembly is comprised of two pusher blocks 177, respective cylinders 12, respective cylinder mounts 175. When base cylinder mount 174 moves plate into compartment 200 it passively pulls electrical conduit chain 180 with it. When base cylinder mount 174 completes its task of pushing a plate into compartment 200, electrical conduit chain 180 deliveries the signal to rod less cylinder 179 to return to home at its start position in ready for pushing the next plate. Electrical conduit chain 180 is supported by chain guide 176. Electrical conduit chain 180 is connected at one end to the top of base cylinder mount 174 and at the other end to the bottom of chain guide 176. Each end is connected to their respective locations by small brackets 181.

Pod

As will be illustrated with respect to an embodiment of pod elevator 4 described infra, pod elevator 4 has two pods which are integral parts of pod elevator 4.

Pod 3 is a container that receives bar coded plates from indexer 2 (the pod loading machine) and loads the pod with the plates. The plates are loaded in a horizontal position. Pod 3 is then transported to a station in close proximity to a printing press. A press person extracts each plate from the pod, one by one, and locks-down each plate on the selected press cylinder. Pod 3 has several compartments 200 that are separated from one another by parallel partitions 201 (consisting primarily of rails 219), each of which are in separate vertically spaced positions. Indexer 2 loads the bar coded plates into the various compartments 200 of pod 3, as designated by system 1, in succession by moving indexer elevator 101 incrementally up or down until it is in horizontal alignment with the bar coded plate's assigned pod compartment 200, resulting in plates stacked in individual compartments 200, one above another. In one embodiment of pod 3, there are 16 compartments 200.

Pod 3 can be integrated with an elevator 4 for movement of the plates stored in pod 3 to the press. Pod 3 is in a horizontal position in elevator 4 after it is loaded with plates. The pod can then be swiveled through an arc of 90° to bring it into a vertical position within elevator 4 for vertical movement by elevator 4. The plates ride within pod 3 in an upright-vertical position, suspended by a bend along one edge of the plate, the bend having been made by punch/bender 19. Vertically hung pod 3 is transported (lowered or raised, as the case may be) by pod elevator 4 to a station where the plates contained therein will be loaded onto a designated press cylinder, according to each plate's bar coded information.

Each parallel compartment 200 of pod 3 is provided with a plate hanger 202. Plate hangar 202 is designed to enable the relatively fragile plates to be rotated 90° from their horizontal positions to vertical positions without damage to the plates. After rotation, the plates are automatically suspended on hangers 202 in vertical positions. Hangers may be made of a plastic material for avoidance of plate scratching. Hanger 202 is affixed longitudinally to enclosure base 223. Hanger 202 is comprised of a top bracket 202A connected to an angled bracket 202B. Top bracket 202A is in-parallel with the bottom surface of the plate and the bottom surface of the plate rests on top bracket 202A. Projecting downward from top bracket 202A and from the bottom surface of the plate is angled bracket 202B. Angled bracket 202B projects downward at an angle that is over 90° from top bracket 202 to form an anvil shaped hanger 202. The bend along one edge of the plate is tucked around the point where the top bracket 202A and the angled bracket 202B meet, thereby hooking the anvil shaped bend on the edge of the plate over hanger 202.

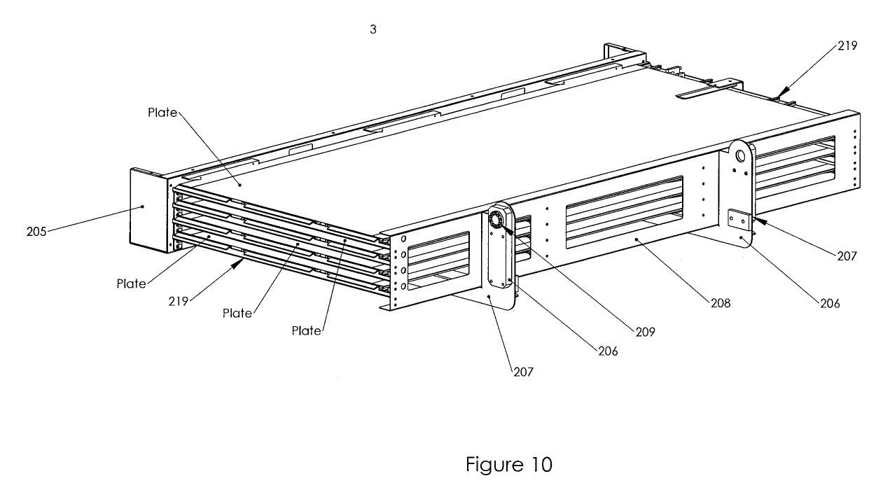

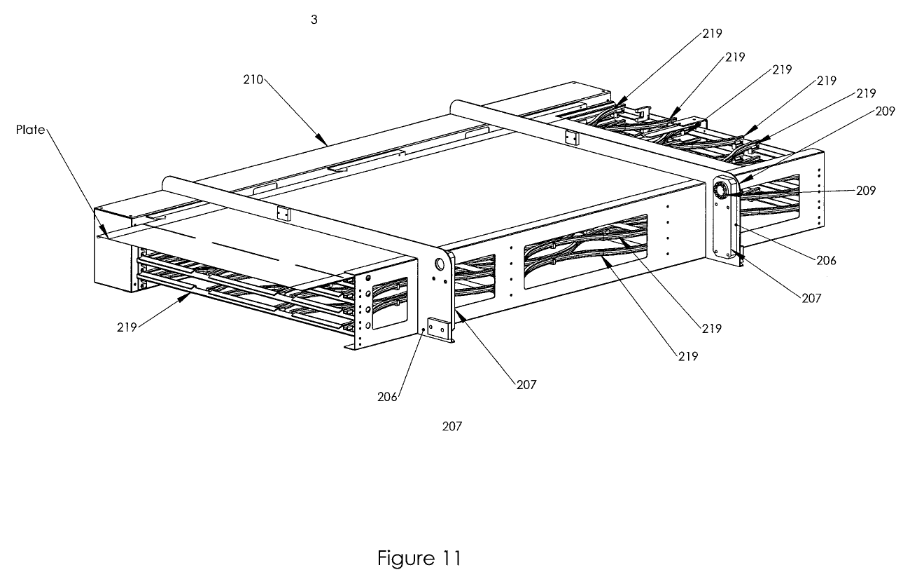

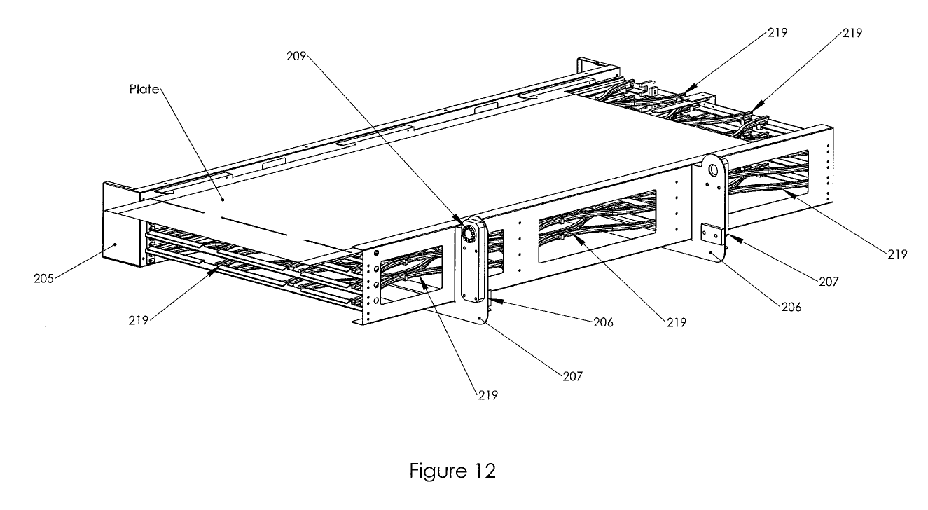

FIG. 9 is a perspective view of an embodiment of upper pod 3, fully loaded with plates (the plates are shown in grey). FIG. 10 is a perspective view of an embodiment of lower pod 3, fully loaded with plates. FIG. 11 is a perspective view of an embodiment of upper pod 3 with one partially loaded plate. FIG. 12 is a perspective view of an embodiment of lower pod 3 with one partially loaded plate. Enclosure 217 is comprised of base 223, cover 214, and two end caps 205. Opposite enclosure 217 is channel shaped retainer 208. Enclosure and channel shaped retainer are tied together by a support member 226 affixed from a first end of enclosure 217 to a first end of channel shaped retainer 208. Another support member 226 is affixed in the same manner between the second end of enclosure 217 and the second end of channel shaped retainer 208. Two L-shaped supports 206 extend, in parallel, across the top of pod 3 and provide rigid transverse bracing between enclosure 217 and channel shaped retainer 208. L-shaped supports 206 are respectively affixed at their ends to enclosure cover 214 and to the top of channel shaped retainer 208A and to the face of channel shaped retainer 208B. Curvilinear rails 219 are connected between support members 226 at both ends of pod 3. Curvilinear rails 219 support the lithographic plates and form the partitions 201 between the compartments 200 of the pod. Each compartment 200 comprises a separate envelope for a separate plate.

Facing mounting blocks 207 are affixed to those portions of L-shaped supports 206 that are in contact with channel shaped retainer 208. Mounting blocks 207 provide rigidity to that portion of the L-shaped supports 206. Mounting blocks 207 also include keyless hubs 209 with apertures for insertion of pivot shaft 310 between opposing keyless hubs 209. Pivot shaft 310 is used by a pod elevator 4 to vertically move pod 3.

Two dual rod cylinders 212A are mounted in enclosure 217. Both cylinders 212A act to gently push the plate towards channel shaped retainer 208 and bring the apex of the anvil shaped bend of the plate in mating contact with the apex of anvil shaped hanger 202. The effect is that the plate is held firmly in place in pod 3 during movement of the pod and damage to the plate is virtually eliminated.

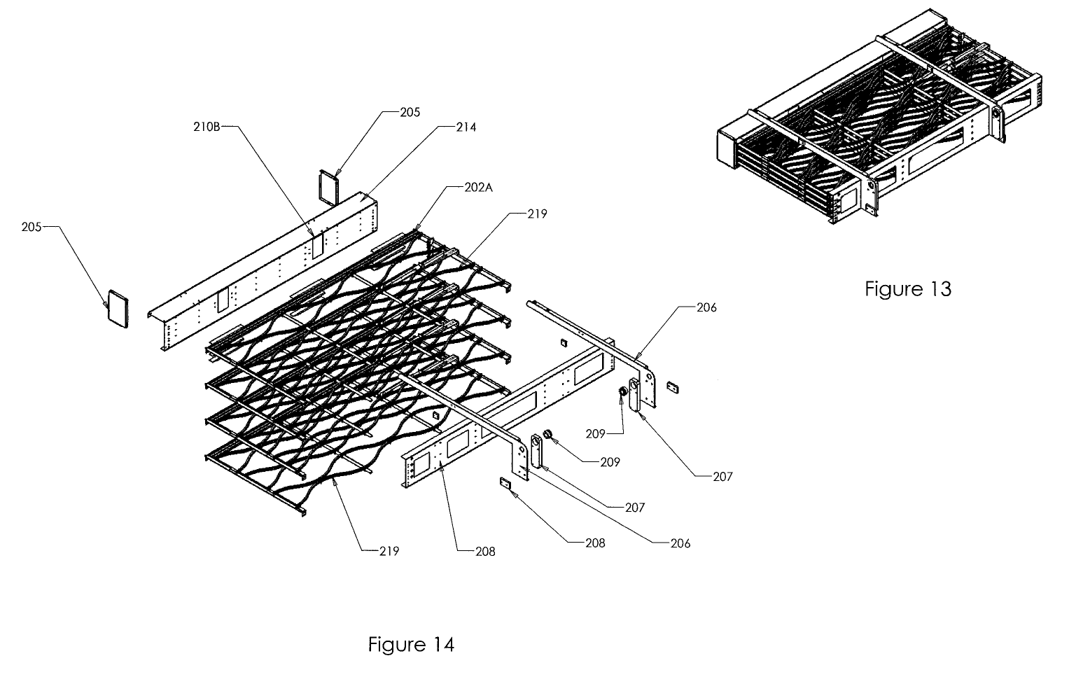

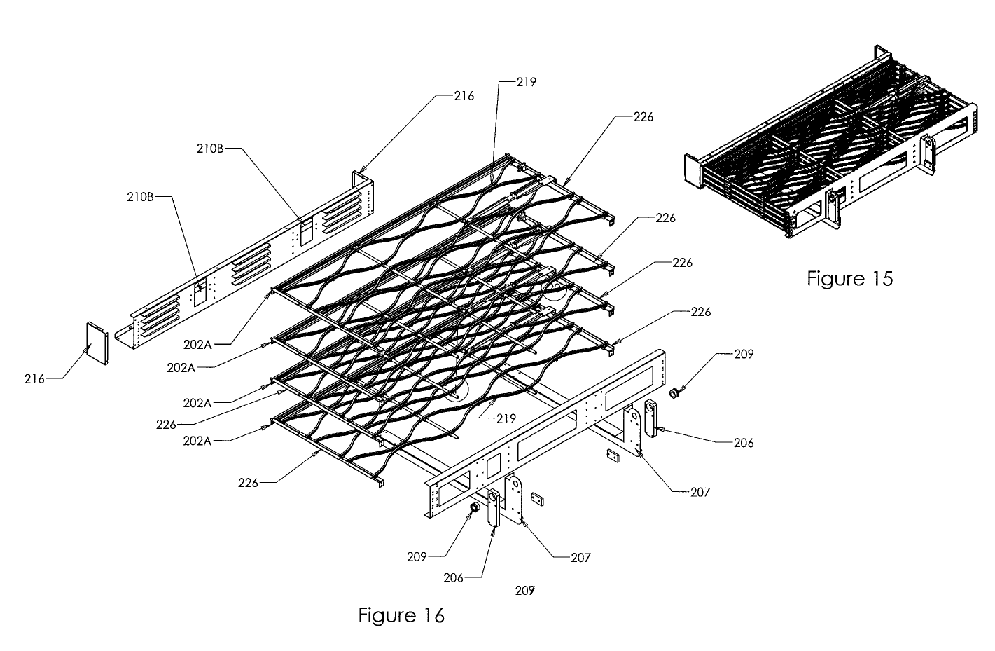

FIG. 13 is a perspective view of an embodiment of upper pod 3 without any plates loaded. FIG. 14 is an exploded view of an embodiment of upper pod 3. FIG. 15 is a perspective view of an embodiment of lower pod 3 without any plates loaded. FIG. 16 is an exploded view of an embodiment of lower pod 3. They illustrate, among other things, two dual rod cylinders 212A in enclosure 217. Dual rod cylinders 212A are a part of dual rod cylinder assembly 212B, which also includes nut plate 213, brackets 211A and B, compression shoe 218, and pad 210A. Assembly 212B is attached by brackets 211A and B mounted from the inside of cover 214 to each side of pad window 210B. Compression shoe 218 and pad 210A are sized so that when the dual rods are extended from dual rod cylinder 212A, the shoe 218 and pad 210A are able to pass through pad window 210B and gently push the bent side of the plate firmly against the apex of the anvil shaped hanger 202. Pad 210A may be a neoprene strip to cushion its push against the bent side of the plate.

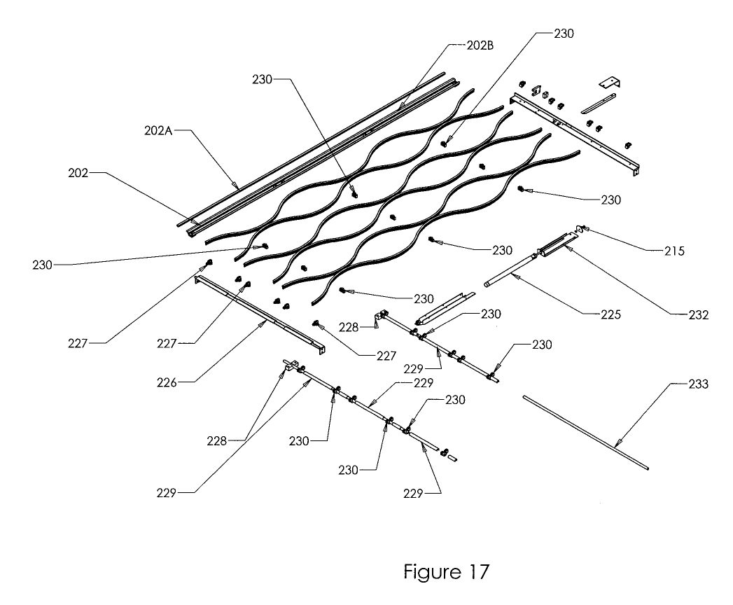

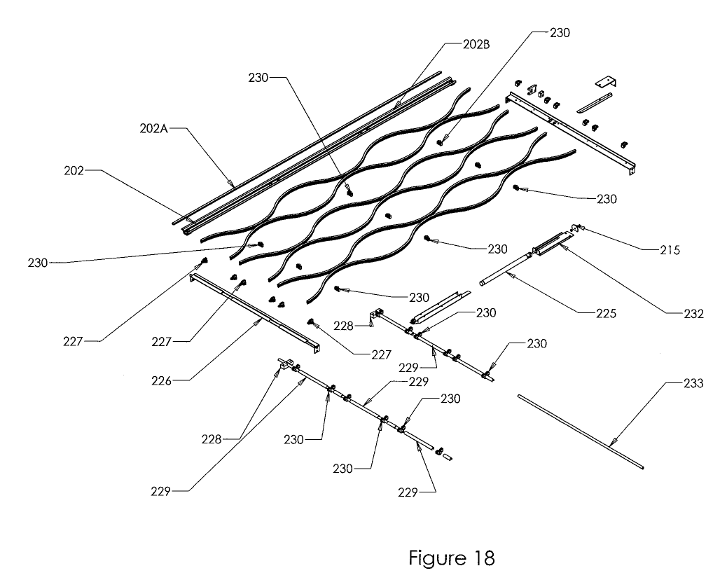

FIG. 17 is an exploded view of an embodiment of the partition and ejector of upper pod 3. FIG. 18 is an exploded view of an embodiment of the partition and ejector of lower pod 3. Partition 201 is comprised of curvi-linear rails 219. Rails 219 are connected to transverse rail supports 226 at the first and second ends of pod 3 with snap lock clips 227. Snap lock clips 227 are fastened to rail supports 226 and the ends of rail 219 are snapped into the top of snap lock clips 227. As shown in the figures, pinch lock clips 230 hold a set of two rails 219 together at the point where rails 219 abut one another. Support shaft 233 extends transversely across rails 219. Pinch lock clips 230 are spaced on shaft 233 so each clip 230 locks onto a single rail 219 where rails 219 abut one another. The spacing is shown in FIGS. 17-18. Spacing is maintained by round spacers 229 lying in between the spacers on support shaft 233. As shown in the figures, there are three such support shafts 233. However, there can be more or fewer shafts depending upon the length of the rails/partitions. A T-clamp 228 is attached to hanger 202 at the end of support shaft 233 and tied into channel shaped retainer 208. The top of hanger 202A is in the same plane as the top of rails 219.

A plate ejector 215 is comprised of a single rod cylinder 225 and mounting bracket 232. The cylinder is mounted on mounting bracket 232 and the bracket is affixed to support member 226 on the second end of each pod compartment 200. Ejection cylinder 215 extends in a direction from the second end of each pod compartment 200 to the first end of each pod compartment 200. As the ejection cylinder 215 is extended it ejects the plate from its compartment towards the second end of pod 3, one at a time, into the hands of a printer who will place the plate on the press cylinder. Plate ejector 215 retracts its cylinder 225 upon reaching its maximum travel point. To eject the plates, the printer signals system 1 to open pod door 204. When pod door 204 opens, plate ejector 215 associated with a designated compartment 200 dispenses the plate from that compartment into the hands of the printer.

Pod elevator 4 can be scaled up or down to move more or less than 2 pods 3. The basic configuration of pod elevator 4 is the same regardless of pod capacity, except that the size of elevator 4 is scaled up or down (in for example, its height, pod capacity, or the size of the lithographic plate) to meet the needs of a customer's pre-press configuration.

Cart Pod

The cart pod serves a similar function as does the pod, albeit in a less automated manner. Primarily the cart pod is less automated because it cannot interface with the pod elevator and it is generally a wheeled device. It does however fully interface with the indexer and is loaded by the indexer in the same manner the indexer loads the pod. Once it is loaded with plates it is transported proximate the press cylinder, where the plates are unloaded and locked-up on a press cylinder. The cart pod is configured to be loaded with plates one at a time by the indexer. The configuration includes dimensional attributes that allows the cart pod to be in alignment with the pusher end of the indexer as if it were a pod. In this manner the pusher end of the indexer is in-line compatible with the cart pod. Moreover, the cart pod is configured to accept the same size plates as does the pod. The pusher assembly of the indexer pushes the plate into the cart pod in the same manner as it does with the pod. The cart pod also has separate vertically spaced compartments as does the pod. The indexer pushes plates into the separate cart pod compartments in succession by lowering the compartments incrementally as the plates are loaded by the pusher assembly, whereby the plates are stacked in individual positions one above another. Parallel partitions separate the cart pod and pod compartments. The elevator moves a plate in a vertical direction into horizontal alignment with the cart pod compartment that corresponds to a code on the plate. The compartments are indexed at a pre-determined vertical position of the indexer. A linear encoder senses the point at which the elevator has reached a specified vertical location corresponding to the assigned cart pod compartment, at which point the elevator stops. Pusher finger assemblies proximate each side of the plate align the plate with the elevator and the assigned cart pod compartment. Upon completion of alignment of the plate with the elevator and assigned cart pod compartment the indexer conveyor initiates forward movement of the plate into the assigned cart pod compartment and upon sensing the trailing edge of the plate by the second indexer sensor means, a plate assist assembly pushes the trailing edge fully into the assigned cart pod compartment.

Pod Elevator

The structure of pod elevator 4 is described, followed by the description of its operation.

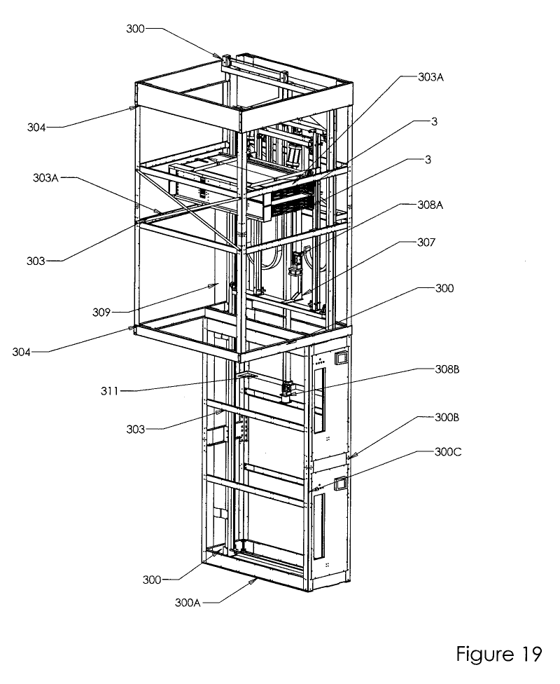

FIG. 19 best illustrates the frame of pod elevator 4. The frame is comprised of multiple frame members 300. Frame members 300 form the skeleton of pod elevator 4. Pod elevator 4 is most often mounted to a wall by mounting pads 304. To assure stability, pod elevator 4 is also floor-mounted by, for example, bolting the elevator into the floor through mounting frame members 300A. The top and bottom portions of elevator 4 are bolted together through top assembly pad 305A, located at the end of back frame member 300B of the top portion, and through bottom assembly pad 305B, located at the end of back frame member 300B of the bottom portion. The bottom portion of elevator 4 also has two front, upward extending legs 300C each with an assembly pad 305C and 305D which are bolted together. The top portion of elevator 4 is cantilevered over the bottom portion. The bottom portion of elevator 4 is sized to fit through a hole in a ceiling. The cantilevered top portion is above the ceiling and bolted to the bottom portion of elevator 4. The top portion has a larger footprint that the bottom portion. Diagonal stabilizers 303 and cross-members 303A strengthen elevator frame members 300 and act as sway bracing, among other things.

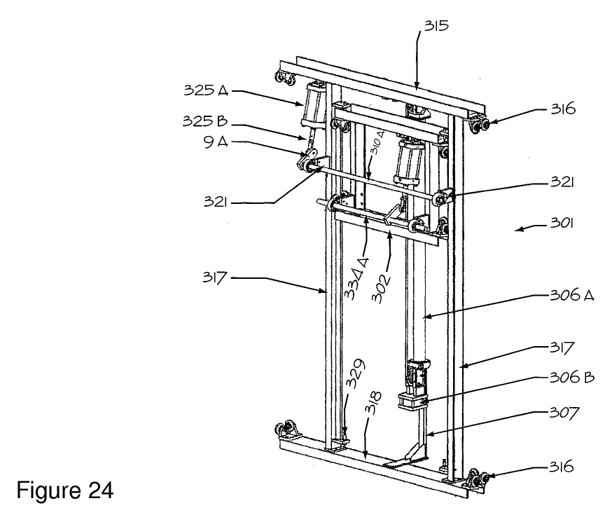

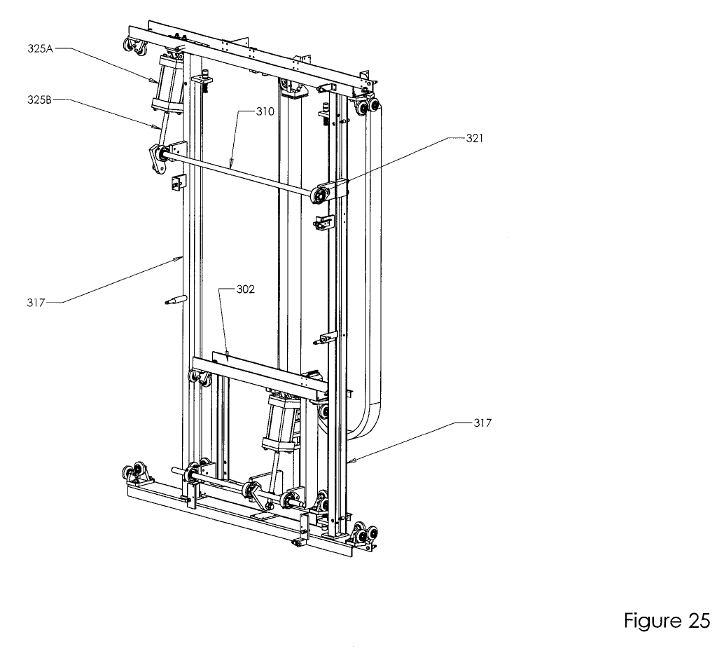

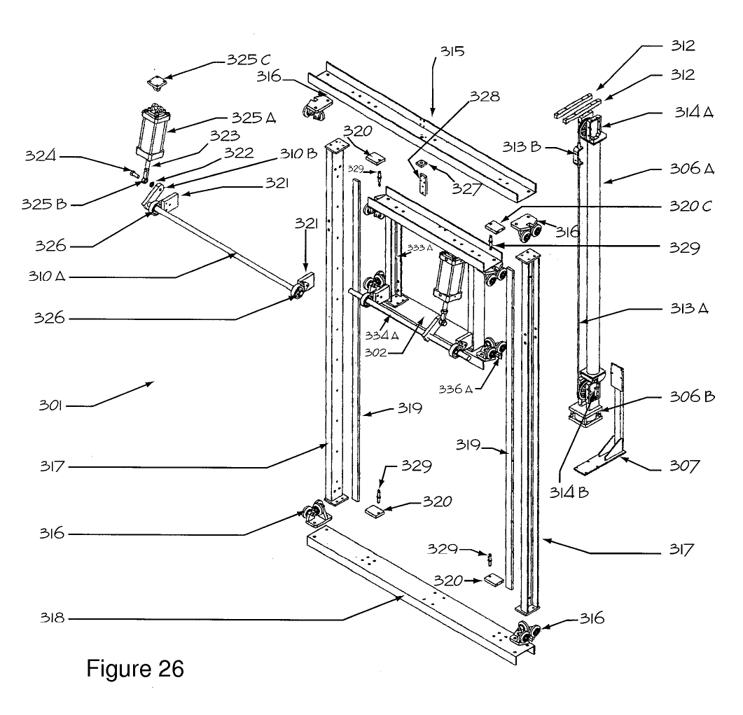

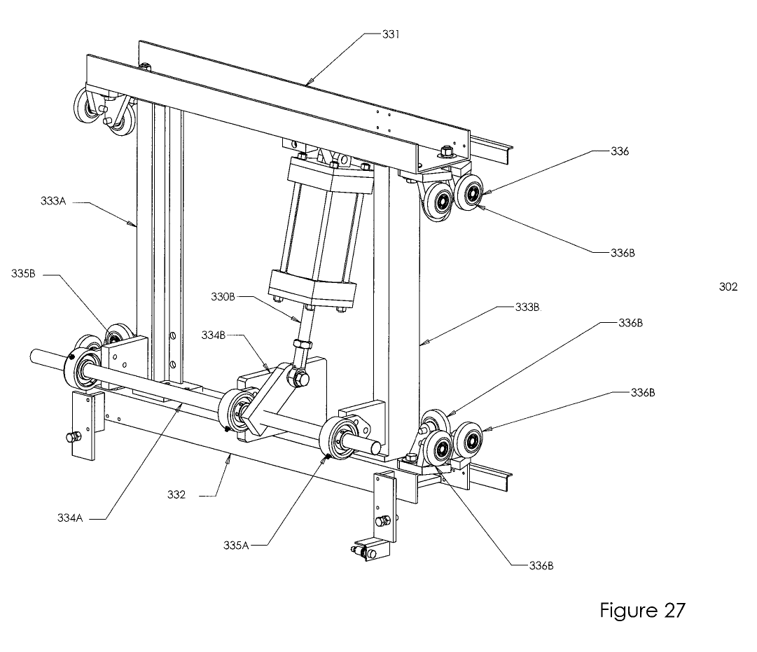

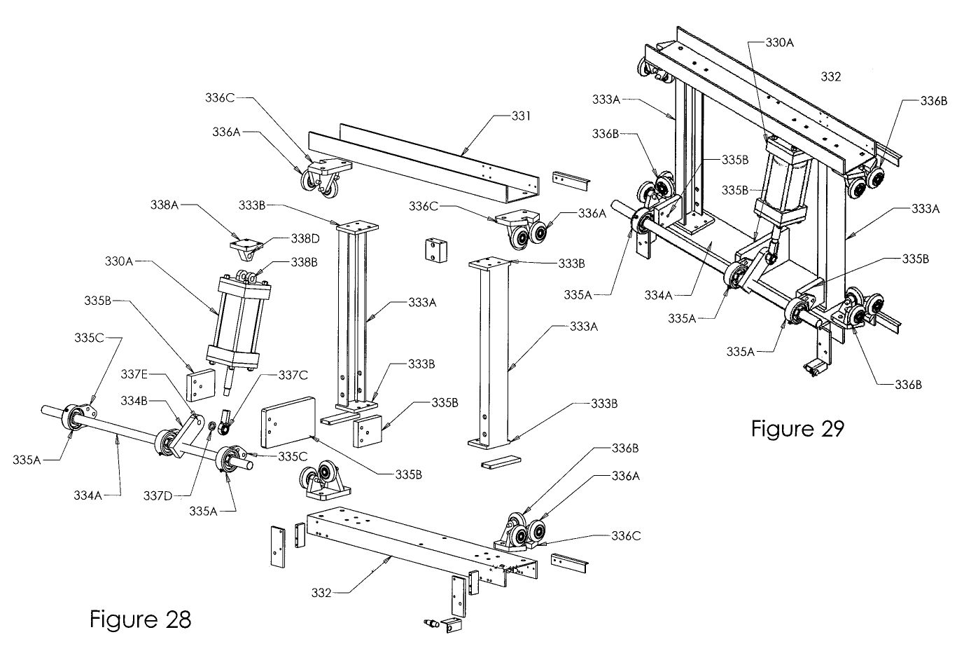

The operating parts of pod elevator are outer carriage 301 and inner carriage 302. FIGS. 24-26 illustrate the structure of outer carriage 301 and to some degree, inner carriage 302. FIG. 24 illustrates inner carriage 302 in an up-position relative to outer carriage 301. FIG. 25 illustrates inner carriage 302 in a down-position relative to outer carriage 301. FIG. 26 is an exploded view of the structure of outer carriage 301 and to some degree, inner carriage 302. FIGS. 27-29 illustrate inner carriage 302.

The exploded view of FIG. 26 best illustrates the structure of outer carriage 301. The frame of outer carriage 301 includes bottom angle bracket 318, left and right side channels 317, and top angle bracket 315. Each frame member is securely bolted or welded together. Left and right guide rails 319 are affixed to the insides of left and right side channels 317 and run more or less the full length of left and right side channels 317. Four guide roller assemblies 316 lie outboard of side channels 317; a pair mounted on the top of bottom angle bracket 318 and a pair on the bottom of top angle bracket 315. Shock absorbers 329 are mounted on shock mounts 320 at the top and the bottom of guide rails 319. They project upward from the bottom of the guide rails 319 and downward from the top of guide rails 319 to absorb whatever light shock may occur when inner carriage 302 bottoms out at the end of its downward travel along guide rails 319 and when it tops out at the end of its upward travel along guide rails 319. Cable cylinder 306A is attached to bottom angle bracket 318 by intermediate mount 307. Mount 307 offsets cylinder 306A from bracket 318 to allow clearance between inner carriage 302 and the cable cylinder. Likewise, cylinder plate mounts 312 perform the same function at the top of cable cylinder 306A. Cable 313A is attached to the top angle bracket of inner carriage 302 by cable travel stop 313B so that cable cylinder motor 306B is able to move inner carriage 302 up and down within outer carriage 301 as and when signaled to do so by system 1.

FIGS. 27-29 illustrate inner carriage 302. Inner carriage 302 is similar in certain respects to outer carriage 301. Inner carriage 302 is comprised of left and right side channels 333A. Each channel has mounting bracket 333B at its top and bottom for mounting channels 333A to top angle bracket 331 and to bottom angle bracket 332. Guide roller assemblies 336 are affixed to the top surface of bottom angle bracket 332 and to the bottom surface of top angle bracket 331. Guide roller assemblies 336A include rollers 336B and mounting brackets 336C on which rollers 336B are rotatably affixed. Shaft 334A has bearing 335A at each end. Each bearing has a mounting flange 335C. Mounting flanges 335C are attached to bearing mounts 335B, which in turn are affixed to side channels 333. Pivot 334B is affixed to shaft 334A between bearings 335A. Pivot 334B is connected to cylinder rod 330B by cylinder attachment assembly 337A. Assembly 337A includes, for example, a threaded bolt 337B, an aperture 337C in cylinder rod 330B, a spacer 337D, and an aperture 337E in pivot 334B. Bolt 337B is inserted through aperture an aperture 337C in the cylinder rod and through spacer an aperture 337D. It is then threaded into aperture 337E in pivot 334B. Cylinder 330A is attached to mounting plate 338A by pin 338B through eyes 338C of cylinder 330A and through eye 338D of mounting plate 338A. Mounting plate 338A is mounted to the bottom of top angle bracket 331.

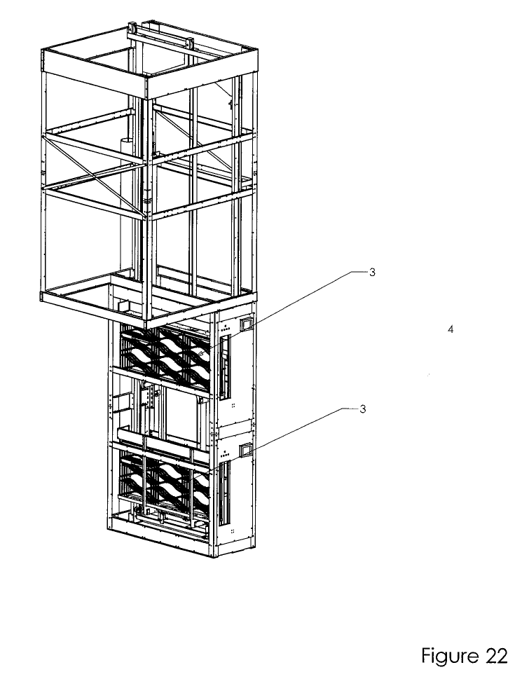

FIGS. 19-23 illustrate pod elevator 4 with two pods 3. Pods 3 are stacked in elevator 4, prior to putting the elevator in service. The pods are an integral part of elevator 4. They are not intended to be removed in the normal course of the printing operation. However, the pods can be removed with little difficulty and used to store the lithographic plates for use at a later time.

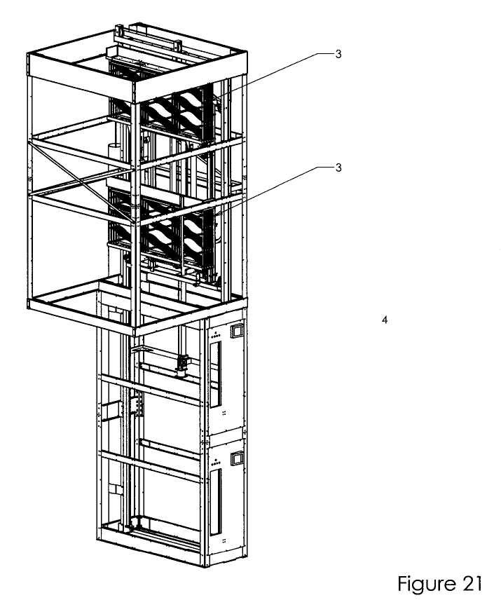

As previously mentioned and as shown in FIG. 19, an embodiment of elevator 4 has two pods 3. The upper pod is held by outer carriage 301. The lower pod is held by inner carriage 302. L-shaped supports 206 can be seen on the top of the upper pod. FIG. 26 shows shaft 310A. The shaft extends through keyless hubs 209 in each L-shaped support of the upper pod. Shaft 310A is rotatably held in bearings 326, which are affixed to left and right side channels 317 of elevator 4 (FIGS. 24-26). Shaft 310A inserts into an aperture in one end of pivot 310B of the upper pod and is non-rotatably affixed in the angular position shown in FIGS. 24 and 26. Cylinder rod 325B of cylinder 325A is rotatably connected to pivot 310B at the other end of pivot 310B. The top end of cylinder 310A is rotatably connected to the bottom of top angle bracket 315. When cylinder 310A is actuated by system 1, rod 325B moves downward, rotates shaft 310A clockwise 90°, and likewise rotates upper pod 3 clockwise 90°. Shaft 310A rotates pod 3 clockwise 90° due to the fact that shaft 310A is gripped by the two keyless hubs 209 on pod 3. The clockwise rotation of pod 3 around shaft 310A forces enclosure 217 of the upper pod to also rotate 90° with the result that the formerly horizontal upper pod is vertical with enclosure 217 above channel shaped retainer 208, as can be seen in FIG. 21. Rotation of the lower pod occurs in the same manner as for the upper pod. The difference is that lower pod 3 is pivoted around shaft 334A of inner carriage 302 rather than shaft 310A of outer carriage 301. Lower pod is also oriented differently than upper pod, in that L-shaped supports 206 are on the bottom of lower pod 3. L-shaped supports 206 mounted in this manner so that the two pods are abutting one another in the load plate mode. When abutting, the spacing of the partitions of pod 3 are close enough together so that the upper and lower pods appear to indexer 2 to be a single larger pod. This allows for more efficient loading of the two pods by indexer 2.

The operation of elevator 4 includes six sequential modes.

The first mode shown in FIG. 19 is the “load plate” mode. In the load plate mode, indexer 2 loads bar coded plates into an identified compartment 200 of an identified pod 3, of which there are two. Prior to loading the plates, a bar code reader on indexer 2 reads the bar code of the plate to be loaded. Identifiers for pod 3 and for the compartment 200 (in which the plate will be loaded) in identified pod 3 are sensed by magneto-restrictive transducer 144 mounted on indexer 2. Transducer 144 senses each indexed position of the indexer's elevator 101 as it moves upwardly or downwardly within indexer housing 113. Each indexed position corresponds to the position of a specific compartment 200 in a specific pod 3. The identifier for the compartment, the identifier for the pod, and the bar coded information on the plate is fed back to PLC 31 of plate management and handling system 1 and stored in the PLC's memory. As shown in FIG. 19, upper pod 3 is hung on outer carriage 301 by shaft 310A and is affixed to shaft 310A by keyless hubs 209 of upper pod 3. Lower pod 3 is hung on inner carriage 302 by shaft 334A and is affixed to shaft 334A by keyless hubs 209 of lower pod 3.

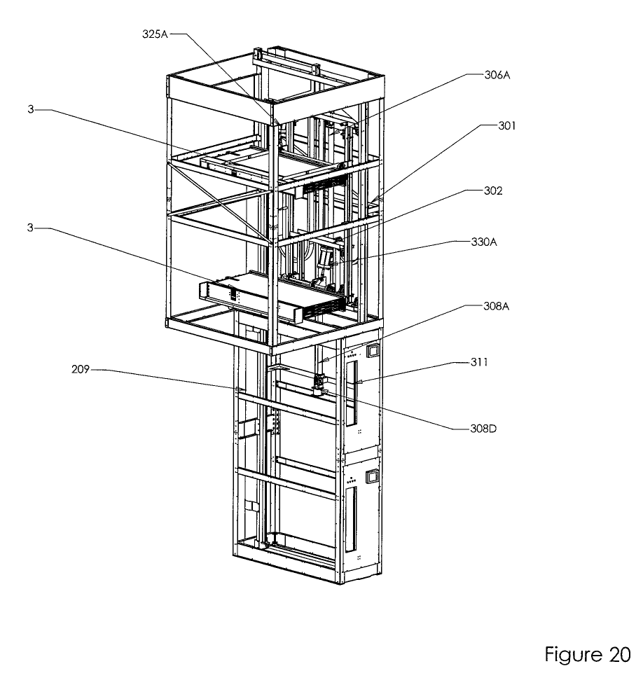

The second mode shown in FIG. 20 is the “separate pod” mode. In this mode, adjacent upper and lower pods 3 of FIG. 19 are vertically separated. During separation, upper pod 3 remains stationary in the load plate position. Upper pod 3 is connected to outer carriage 301, which consequently also remains stationary. Lower pod 3 is connected to inner carriage 302. Inner carriage 302 rides within outer carriage 301. Separation of lower pod 3 from upper pod 3 occurs when inner carriage 302 moves downward within outer carriage 301. Inner carriage 302 moves downward when it receives a signal do so from system 1. Upon receiving the signal, inner carriage 302 is moved down to the bottom of outer carriage 301 by inner carriage cable 313A and its associated parts, comprising four inner carriage cable roller assemblies 336A, inner carriage cable attachment point 313B, inner carriage cable cylinder 306A, and inner carriage cable motor 306B. Inner carriage 302 rides up and down on inner carriage rails 319A and B. Rails 319A and B are captured by the three guide rollers 336B of guide roller assembly 336A. The lower pod is separated from the upper pod by at least a distance equal to the width of pod 3. The width of pod 3 is defined by the distance from the outside of channel shaped retainer 208 to the outside of enclosure 217. During and initially after pod separation, the pods remain in a horizontal position.

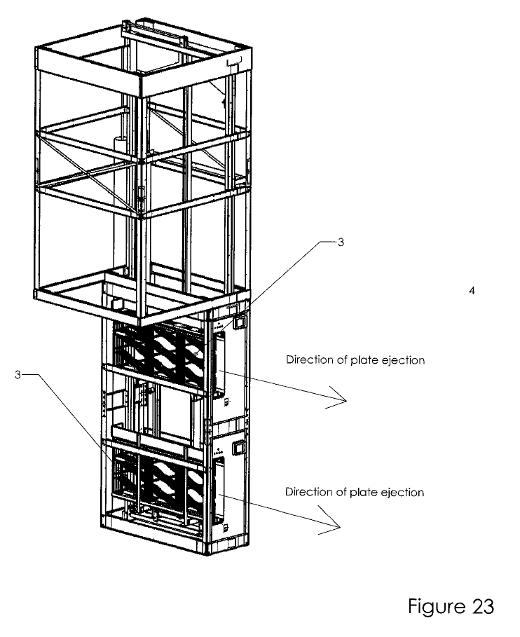

The third mode shown in FIG. 23 is the “rotate pod” mode. In this mode, as previously described, each pod is rotated upwards 90° from its horizontal orientation to a vertical orientation.

The fourth mode shown in FIG. 24 is the “lower pod” mode. In this mode, both of the vertically hung pods of FIG. 23 are moved downwards to the bottom of elevator 4. Downward movement of both of the pods occurs simultaneously by downward movement of outer carriage 301. Outer carriage 301 contains inner carriage 302 and its associated pod. Inner carriage 302 was moved in the lowest position within outer carriage 301 during the “separate pod” mode. Outer carriage 301 moves downward when it receives a signal from system 1 to do so. Upon receiving the signal, outer carriage 301 is moved down to the bottom of pod elevator 4 by outer carriage cable 308B and its associated parts, comprising four outer carriage cable roller assemblies 316, outer carriage cable attachment point 308C (not shown), outer carriage cable cylinder 308A, and outer carriage cable motor 308D. Outer carriage 301 rides up and down on outer carriage rails 319. Rails 319 are captured by guide roller assemblies 316, which are each comprised of 3-rollers.

The fifth mode shown in FIG. 25 is the “eject plate” mode. After the pod elevator's delivery of the plate to a press area, system 1 sends the plate's bar coded information and identifiers for compartment 200 and pod 3 (sometimes referred to as the plate address) to the press-person. The information is most conveniently provided on an electronic display. Among other information, the information tells the press-person on which cylinder the ejected plate is to be placed. In this mode, the press-person signals system 1 to eject the identified plate out of its pod compartment 200 into the hands of the press operator. The press operator then locks the plate on the cylinder designated by the information sent to the display by system 1.

The sixth mode is the “return home mode.” In this mode, system 1 directs pod elevator to return to its home position for further loading of the pods by indexer 2. The sixth mode reverses the sequence of the previously described five modes.

Although the apparatus for loading lithographic plates into a container for transport to a press cylinder and the process thereof have been described with reference to the embodiments, those skilled in the art will recognize that numerous changes may be made in form and detail without departing from the spirit and scope of the apparatus and process.

We claim:

1. A process for transporting lithographic plates, comprising the steps of (a) using an indexer (i) to load an imaged plate, having a machine readable code thereon, into the indexer; (ii) the indexer to move the loaded plate into a position in alignment with a designated pod compartment, the designated pod compartment corresponding to information designated by the machine readable code; and (iii) the indexer loading the plate into the designated pod compartment and (b) using a pod elevator to move the pod proximate to a press cylinder.

2. The process of claim 1, comprising the step of using a computing device for directing steps of the process including modules.

3. The process of claim 2, wherein the computing device comprises (a) memory for storing parameters corresponding to (i) virtual locations of modules comprising a conveyor, the indexer, the pod, a pod compartment, a pod elevator, and a press cylinder; (ii) physical locations of the plates; (iii) machine readable codes on the plates; and (iv) feedback from the modules; (b) instructions for directing movement of the plate along routes based upon preset parameters; (c) a processor for executing the instructions; (d) an input channel for receiving and storing the instructions and the parameters; and (e) an output channel for sending the instructions to a module for directing an operation and for directing the movement of the plate along routes.

4. The process of claim 3, wherein the computing device is a programmable logic controller.

5. The process of claim 1, wherein the machine readable code is a bar code.

6. The process of claim 2, comprising the step of imaging and processing the plate.

7. The process of claim 2, comprising the step of using a conveyor to move the imaged plate to the indexer.

8. The process of claim 2, comprising the step of punching, bending, shearing, and corner notching the plate.

9. The process of claim 8, comprising the step of registration of the plate to a press cylinder.

10. The process of claim 2, comprising the step of using a vision system for sensing information from a module and a bar code, feeding the information back to the computing device, and the computing device initiating a command.

11. The process of claim 2, comprising the step of unloading the plate from the pod.

12. The process of claim 2, comprising the step of loading the plate onto a press cylinder.

13. The process of claim 2, comprising the step of moving a plurality of plates into pod compartments by indexed movement of an elevator of the indexer to align a designated plate with a pod compartment corresponding to the designated plate.

14. The process of claim 6, comprising the step of registration of the image to plate.

15. A lithographic plate indexer, comprising a frame, housing, elevator, indexer conveyor, plate centering assembly, and plate finger pusher.

16. The indexer of claim 15, wherein the frame is a box frame.

17. The indexer of claim 16, comprising an internal frame secured to the box frame for support of the elevator.

18. The indexer of claim 15, wherein the elevator is vertically movable within the frame and the housing and in a first position the elevator is in a plate loading position and in a second position the elevator is in a plate exiting position.

19. The indexer of claim 18, comprising a means for raising and lowering the elevator

20. The indexer of claim 19, wherein the means for raising and lowering the elevator comprises a drive motor, worm gear assembly, and speed reduction adapter.

21. The indexer of claim 15, wherein the indexer conveyor is comprised of one or more horizontally, rollable belts and a means for rollably moving the belts.

22. The indexer of claim 15, comprising the plate centering assembly having a means for pushing the plate into lateral registration with belts.

23. The indexer of claim 15, comprising a plurality of plate centering assemblies having at least one assembly positioned on each longitudinal side of the plate.

24. The indexer of claim 15, comprising the finger pushers mounted on each longitudinal side of the plate for gripping the plate with the finger springs to move the plate into registration with the bed of the elevator.

25. The indexer of claim 15, comprising a plate assist assembly

26. The indexer of claim 15, wherein the plate assist assembly comprises a rod less cylinder mounted over the top of the indexer conveyor in a direction parallel to movement of the belts, a first a sensor for detecting the trailing edge of a plate and in response thereto the computing device signals the pusher assembly to move the plate into a pod compartment and thereafter return to its start position.

27. A pod for containment of lithographic plates, comprising (a) a housing; (b) partitioned compartments within the housing; (c) a support bracket spanning the housing for mounting the pod in a pod elevator; and (d) a means for ejecting a plate from of the pod.

28. The pod of claim 27, the housing comprising (a) an enclosure; (b) a retainer opposite the enclosure; (c) the partitioned compartments between the enclosure and the retainer; and (d) a support bracket spanning the enclosure, the compartments, and the retainer for mounting the pod in a pod elevator.

29. The pod of claim 27, comprising a plurality of compartments, support brackets, and means for ejecting a plate.

30. The pod of claim 29, wherein the compartments are comprised of vertically spaced apart parallel partitions for containment and support of a plate.

31. The pod of claim 3, comprising upper pod support brackets on an upper pod and lower pod support brackets on a lower pod.

32. The pod of claim 27, wherein the plates are loaded in a horizontal position.

33. The pod of claim 27, comprising a rotatable support for the plate when the pod is in a vertical position within the pod elevator and a dual rod cylinder for engaging a bend on the plate with the hangar.

34. The pod of claim 27, wherein the means for ejecting the plate from of the pod is a plate ejector.

35. The pod of claim 27, comprising assigned pod compartments successively loaded with corresponding coded plates by incremental movement of the indexer elevator.

36. The pod of claim 32, wherein the pod elevator swivels the pods and their contained plates into a vertical position.

37. The pod of claim 36, wherein the vertical pods are transported by the pod elevator proximate to a press cylindrical.

38. The pod of claim 27, comprising support brackets having apertures for rotatable engagement with a pivot shaft of the pod elevator.

39. The pod of claim 34, comprising sending a signal to open a pod door; ejecting the plate from a designated pod compartment; and upon reaching the end of a plate ejector's travel retracting the ejector to its home position.

40. A pod elevator for transport of a pod, comprising a movable outer carriage; a pod movable within the outer carriage; an inner carriage movable within the outer carriage; and a pod movable within the inner carriage.

41. The pod elevator of claim 40, comprising a frame having frame members; mounting frame members; back frame members; stabilizers; cross-members; and legs.

42. The pod elevator of claim 40, comprising the frame having a frame top portion and a frame bottom portion.

43. The pod elevator of claim 42, comprising the frame having the top portion cantilevered over the bottom portion.

44. The pod elevator of claim 40, comprising the outer carriage having (a) a frame with left and right side channels and top and bottom angle brackets; (b) a guide rail affixed to the inside of the left channel; (c) a guide rail affixed to the inside of the right channel; (d) two guide roller assemblies mounted on the top angle bracket positioned to the left and right of the side channels; (e) two guide roller assemblies mounted on the bottom angle bracket positioned to the left and right of the side channels; (f) a cable cylinder mounted to the top and the bottom angle brackets and a cable attached to a top angle bracket of the inner carriage by a cable travel stop; (g) a rotatable shaft in opposing end bearings, the bearings affixed to the left and the right side channels; (h) a pivot affixed at one end in a pre-determined angular position to the shaft and rotatably connected at the other end to a cylinder and the top end of the cylinder rotatably connected to the bottom of the top angle bracket.

45. The pod elevator of claim 40, comprising the inner carriage having (a) a frame with left and right side channels and top and bottom angle brackets; (b) four guide roller assemblies mounted on the top and the bottom angle brackets positioned outside of the left and right side channels; (c) a shaft in end bearings; (d) a pivot affixed between the shaft and a cylinder rod and the cylinder pivotally affixed to the top angle bracket.

46. The pod elevator of claim 41, wherein the outer carriage is movable within the frame; an upper pod is movable within the outer carriage; and a lower pod is movable within the inner carriage.

47. The pod elevator of claim 40, comprising support brackets on top of the upper pod and support brackets on the bottom of the lower pod.

48. The pod elevator of claim 47, comprising the outer carriage having (a) a rotatable shaft in opposing end bearings, the bearings affixed to left and right side channels and (b) one end of a pivot affixed to the shaft in a pre-determined angular position, the other end of the shaft rotatably affixed to a cylinder, and the top end of the cylinder rotatably affixed to the top angle bracket.

49. The pod elevator of claim 10, comprising the upper pod rotatably affixed on the shaft by insertion of the shaft though apertures in the upper support brackets.

50. The pod elevator of claim 48, comprising actuation of the outer carriage cylinder to extend the rod downward to clockwise rotate the shaft and the upper pod 90° upward.

51. The pod elevator of claim 50, comprising the inner carriage having (a) a rotatable shaft in opposing end bearings, the bearings affixed to the left and right side channels and (b) one end of a pivot affixed to the shaft in a pre-determined angular position, the other end of the shaft rotatably affixed to a cylinder, and the top end of the cylinder rotatably affixed to the top angle bracket.

52. The pod elevator of claim 51, comprising the lower pod rotatably affixed on the shaft by insertion of the shaft though apertures in the lower support brackets.

53. The pod elevator of claim 52, comprising actuation of the inner carriage cylinder to extend the rod downward to clockwise rotate the shaft and the lower pod 90° upward.

54. The pod elevator of claim 53, comprising the load plate mode; separate pod mode; rotate pod mode; lower pod mode; eject plate mode; and return home mode.

55. The pod elevator of claim 54, comprising the load plate mode having (a) the upper pod positioned horizontally on the upper shaft in the outer carriage; (b) the lower pod positioned horizontally on the lower shaft in the outer carriage; (c) the bottom of the upper pod abutting the top of the lower pod; and (d) whereby the indexer can load the upper and lower pods as if they were a single pod.

56. The pod elevator of claim 55, comprising the separate pod mode having the horizontal upper pod remaining stationary and the horizontal lower pod separating from the upper pod by movement of the inner carriage downward to the bottom of the outer carriage at least a distance from the outside of the channel shaped retainer to the outside of the enclosure.

57. The pod elevator of claim 56, comprising the rotate pod mode rotating the upper and lower pods upward from their horizontal positions to vertical positions.

58. The pod elevator of claim 57, comprising the lower pod mode (a) moving the outer carriage, along with the vertical upper pod, towards the bottom of the elevator; (b) moving the inner carriage, located at the bottom of the outer carriage, along with the vertical lower pod to the bottom of the elevator; (c) wherein the upper pod remains in it vertical position about the vertically positioned lower pod.

59. The pod elevator of claim 58, comprising the eject plate mode ejecting designated plates from compartments in the upper and lower pods.

60. The pod elevator of claim 59, comprising the return home mode directing the elevator to return to its home position for loading.

61. The pod elevator of claim 60, comprising actuation of the inner carriage cylinder to extend the rod downward to clockwise rotate the shaft and the lower pod 90°.

62. A lithographic plate transport apparatus, comprising an indexer having (a) a plate loading end; (b) an elevator for transporting a plate from the plate loading end to a plate pusher end; (c) a means for pushing the plate into a pod; (d) separate vertically spaced pod compartments for storage of a plate in the pod; and (e) a pod elevator for transporting the pod from the indexer to a location proximate a press cylinder.

63. The apparatus of claim 62, wherein the means for pushing the plate into the pod is a pusher assembly.

64. The apparatus of claim 1, wherein the indexer pushes plates into separate pod compartments in succession by lowering the compartments incrementally as the plates are loaded by the pusher assembly, whereby the plates are stacked in individual positions one above another.

65. The apparatus of claim 62, comprising pod compartments separated from one another by parallel partitions.

66. The apparatus of claim 62, wherein printing press ready plates are loaded into the plate loading end of the indexer one at a time.

67. The apparatus of claim 66, comprising (a) a first indexer sensor means for sensing entry of the leading edge of the incoming plate; (b) in response to the first indexer sensor means an indexer conveyor moves the plate forward proximate to a second indexer sensor means; (c) in response to the second indexer sensor means indication that the plate is fully loaded into the indexer conveyor the plate stops further movement.

68. The apparatus of claim 67, comprising the elevator having a plate thereon movable into horizontal alignment with an assigned pod compartment corresponding to a code on the plate.

69. The apparatus of claim 68, comprising each compartment indexed at a pre-determined position of the indexer.

70. The apparatus of claim 69, comprising a linear encoder for sensing the point at which the elevator has reached a specified location corresponding to the assigned pod compartment, at which point the elevator stops.

71. The apparatus of claim 70, comprising pusher finger assemblies proximate each side of the plate to align the plate with the elevator and the assigned pod compartment.

72. The apparatus of claim 71, wherein (a) upon completion of alignment of the plate with the elevator and assigned pod the indexer conveyor initiates forward movement of the plate into the assigned pod compartment and (b) upon sensing the trailing edge of the plate by the second indexer sensor means a plate assist assembly pushes the trailing edge fully into the assigned pod compartment.

73. The apparatus of claim 72, wherein after the plate is fully lodged in the assigned compartment, the indexer elevator returns to the plate loading end and repeats the cycle.

74. A lithographic plate transport apparatus, comprising an indexer having (a) a plate loading end; (b) an elevator for transporting a plate from the plate loading end to a plate pusher end; (c) a pusher assembly for pushing the plate into a cart pod; and (d) separate vertically spaced cart pod compartments for storage of a plate in the cart pod.

75. The apparatus of claim 74, wherein the indexer pushes plates into separate cart pod compartments in succession by lowering the compartments incrementally as the plates are loaded by the pusher assembly, whereby the plates are stacked in individual positions one above another.

76. The apparatus of claim 74, comprising cart pod compartments separated from one another by parallel partitions.

77. The apparatus of claim 74, wherein printing press ready plates are loaded into the plate loading end of the indexer one at a time.

78. The apparatus of claim 77, comprising (a) a first indexer sensor means for sensing entry of the leading edge of the incoming plate; (b) an indexer conveyor, in response to the first indexer sensor means, moving the plate forward proximate to a second indexer sensor means; (c) the plate, in response to the second indexer sensor means, is stopped from further movement, whereby the plate is fully loaded into the indexer conveyor.

79. The apparatus of claim 78, comprising the elevator with a plate thereon movable in a vertical direction into horizontal alignment with an assigned cart pod compartment corresponding to a code on the plate.

80. The apparatus of claim 79, comprising each cart pod compartment indexed at a pre-determined vertical position of the indexer.

81. The apparatus of claim 80, comprising a linear encoder for sensing the point at which the elevator has reached a specified vertical location corresponding to the assigned cart pod compartment, at which point the elevator stops.

82. The apparatus of claim 81, comprising pusher finger assemblies proximate each side of the plate to align the plate with the elevator and the assigned cart pod compartment.

83. The apparatus of claim 82, comprising pusher finger assemblies proximate each side of the plate to align the plate with the elevator and the assigned cart pod compartment.

84. The apparatus of claim 83, wherein (a) upon completion of alignment of the plate with the elevator and assigned cart pod compartment the indexer conveyor initiates forward movement of the plate into the assigned cart pod compartment and (b) upon sensing the trailing edge of the plate by the second indexer sensor means, a plate assist assembly pushes the trailing edge fully into the assigned cart pod compartment.

85. The apparatus of claim 84, wherein after the plate is fully lodged in the assigned cart pod compartment, the indexer elevator returns to the plate loading end and repeats the cycle.
